(19) United States
(12) Patent Application Publication
(10) Pub. No.: US 2015/0281980 A1
(43) Pub. Date: Oct. 1, 2015

(54) EDCA ADJUSTMENT FOR POOR PERFORMANCE NODES

(71) Applicant: QUALCOMM Incorporated, San Diego, CA (US)

(72) Inventors: Yan ZHOU, San Diego, CA (US); Simone MERLIN, San Diego, CA (US); Gwendolyn Denise BARRIAC, Encinitas, CA (US)

(21) Appl. No.: 14/673,722

(22) Filed: Mar. 30, 2015

Related U.S. Application Data
(60) Provisional application No. 61/973,748, filed on Apr. 1, 2014.

(51) Int. Cl. H04W 24/02; H04W 28/02; H04W 24/08

(52) U.S. Cl. CPC H04W 24/02; H04W 24/08; H04W 28/0268

(57) ABSTRACT

A method, an apparatus, and a computer program product for wireless communication are provided. The apparatus may be a node. The node may suffer poor QoS due to low medium usage caused by a number of contenders. The apparatus obtains node information of the node. The apparatus receives configuration information from a configuring device. The apparatus determines whether to trigger an enhanced distributed channel access (EDCA) adjustment based on at least one of the configuration information or the node information. A purpose of the adjustment is to improve the node's QoS by increasing the aggressiveness of node's EDCA parameters or by reducing the aggressiveness of neighboring nodes' EDCA parameters.

### CROSS-REFERENCE TO RELATED APPLICATION(S)

This application claims the benefit of U.S. Provisional Application Ser. No. 61/973,748, entitled “EDCA ADJUSTMENT FOR POOR PERFORMANCE NODES” and filed on Apr. 1, 2014, which is expressly incorporated by reference herein in its entirety.

### BACKGROUND

1. Field

The present disclosure relates generally to communication systems, and more particularly, to an enhanced distributed channel access (EDCA) adjustment.

2. Background

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, Synchronous Optical Networking (SONET), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc. frequency bands. Wireless networks advantageously facilitate user mobility and rapid field deployment when compared to fixed wired networks.

### SUMMARY

In an aspect of the disclosure, a method, a computer program product, and an apparatus are provided. The apparatus may be a node. The apparatus obtains node information of the node. The apparatus receives configuration information from a configuring device. The apparatus determines whether to trigger an enhanced distributed channel access (EDCA) adjustment based on at least one of the configuration information or the node information.

In another aspect of the disclosure, a method, a computer program product, and an apparatus are provided. The apparatus may be an access point. The apparatus obtains configuration information of the access point. The apparatus receives node information from a node. The apparatus determines whether to trigger an EDCA adjustment based on at least one of the configuration information or the node information.

In another aspect of the disclosure, a method, a computer program product, and an apparatus are provided. The apparatus may be an access point. The apparatus collects node metrics from one or more neighbor access points. The apparatus determines an EDCA adjustment of a node served by the access point based on a node metric of the access point and the node metrics of the one or more neighbor access points. The apparatus coordinates one or more EDCA adjustment phases with the one or more neighbor access points based on the EDCA adjustment of the node.

### BRIEF DESCRIPTION OF THE DRAWINGS

FIG. 1 shows an example wireless communication system in which aspects of the present disclosure may be employed.

FIG. 2 shows a functional block diagram of an example wireless device that may be employed within the wireless communication system of FIG. 1.

FIG. 3 is an example diagram illustrating various nodes and their medium sharing.

FIG. 4 is an example flow diagram illustrating the first approach's first method.

FIG. 5 is an example flow diagram illustrating the first approach's second method.

FIG. 6A is an example flow diagram illustrating the first option of the additional signaling.

FIG. 6B is an example flow diagram illustrating the first option of the additional signaling.

FIG. 7 is an example diagram illustrating a time line of EDCA adjustment phases.

FIG. 8 is an example flow diagram illustrating the second approach's first method.

FIG. 9 is an example flow diagram illustrating the second approach's second method.

FIG. 10 is a flow chart of a method of wireless communication.

FIG. 11 is a flow chart of a method of wireless communication expanding from the flow chart of FIG. 10.

FIG. 12 is a flow chart of a method of wireless communication expanding from the flow chart of FIG. 10.

FIG. 13 is a flow chart of a method of wireless communication.

FIG. 14 is a flow chart of a method of wireless communication expanding from the flow chart of FIG. 13.

FIG. 15 is a flow chart of a method of wireless communication expanding from the flow chart of FIG. 13.

FIG. 16 is a flow chart of a method of wireless communication.

FIG. 17 is a functional block diagram of an example wireless communication device.

### DETAILED DESCRIPTION

Various aspects of the novel systems, apparatuses, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof

Popular wireless network technologies may include various types of wireless local area networks (WLANs). A WLAN may be used to interconnect nearby devices together, employing widely used networking protocols. The various aspects described herein may apply to any communication standard, such as a wireless protocol.

In some aspects, wireless signals may be transmitted according to an 802.11 protocol using orthogonal frequency-division multiplexing (OFDM), direct-sequence spread spectrum (DSSS) communications, a combination of OFDM and DSSS communications, or other schemes. Implementations of the 802.11 protocol may be used for sensors, metering, and smart grid networks. Advantageously, aspects of certain devices implementing the 802.11 protocol may consume less power than devices implementing other wireless protocols, and/or may be used to transmit wireless signals across a relatively long range, for example about one kilometer or longer.

In some implementations, a WLAN includes various devices which are the components that access the wireless network. For example, there may be two types of devices: access points (“APs”) and clients (also referred to as stations, or “STAs”). In general, an AP may serve as a hub or base station for the WLAN and a STA serves as a user of the WLAN. For example, a STA may be a laptop computer, a personal digital assistant (PDA), a mobile phone, etc. In an example, a STA connects to an AP via a WiFi (e.g., IEEE 802.11 protocol) compliant wireless link to obtain general connectivity to the Internet or to other wide area networks. In some implementations a STA may also be used as an AP.

An access point (“AP”) may also comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, connection point, or some other terminology.

A station “STA” may also comprise, be implemented as, or known as an access terminal (“AT”), a subscriber station, a subscriber unit, a mobile station, a remote station, a remote terminal, a user terminal, a user agent, a user device, user equipment, or some other terminology. In some implementations an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

The term “associate,” or “association,” or any variant thereof should be given the broadest meaning possible within the context of the present disclosure. By way of example, when a first apparatus associates with a second apparatus, it should be understood that the two apparatus may be directly associated or intermediate apparatuses may be present. For purposes of brevity, the process for establishing an association between two apparatuses will be described using a handshake protocol that requires an “association request” by one of the apparatus followed by an “association response” by the other apparatus. It will be understood by those skilled in the art the handshake protocol may require other signaling, such as by way of example, signaling to provide authentication.

Any reference to an element herein using a designation such as “first,” “second,” and so forth does not generally limit the quantity or order of those elements. Rather, these designations are used herein as a convenient method of distinguishing between two or more elements or instances of an element. Thus, a reference to first and second elements does not mean that only two elements can be employed, or that the first element must precede the second element. In addition, terminology that recites at least one of a combination of elements (e.g., “at least one of A, B, or C”) refers to one or more of the recited elements (e.g., A, or B, or C, or any combination thereof).

As discussed above, certain devices described herein may implement the 802.11 standard, for example. Such devices, whether used as a STA or AP or other device, may be used for smart metering or in a smart grid network. Such devices may provide sensor applications or be used in home automation. The devices may instead or in addition be used in a healthcare context, for example for personal healthcare. They may also be used for surveillance, to enable extended-range Internet connectivity (e.g. for use with hotspots), or to implement machine-to-machine communications.

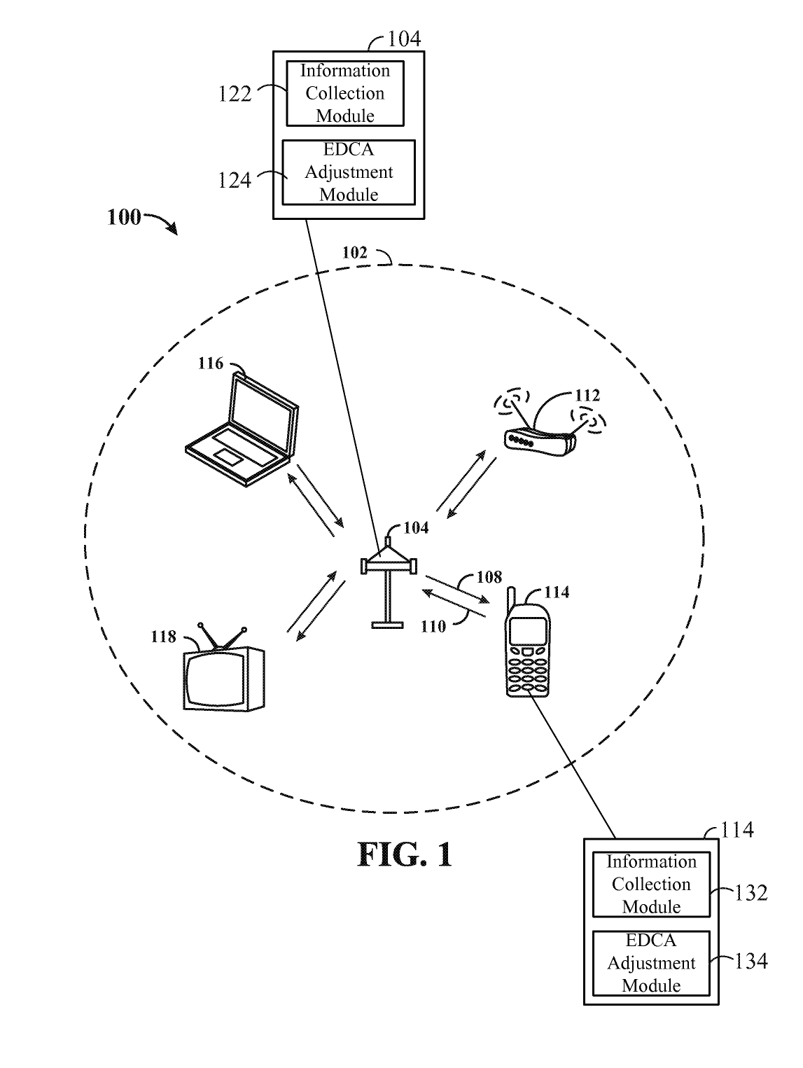

FIG. 1 shows an example wireless communication system 100 in which aspects of the present disclosure may be employed. The wireless communication system 100 may operate pursuant to a wireless standard, for example the 802.11 standard. The wireless communication system 100 may include an AP 104, which communicates with STAs (e.g., STAs 112, 114, 116, and 118).

A variety of processes and methods may be used for transmissions in the wireless communication system 100 between the AP 104 and the STAs. For example, signals may be sent and received between the AP 104 and the STAs in accordance with OFDM/OFDMA techniques. If this is the case, the wireless communication system 100 may be referred to as an OFDM/OFDMA system. Alternatively, signals may be sent and received between the AP 104 and the STAs in accordance with CDMA techniques. If this is the case, the wireless communication system 100 may be referred to as a CDMA system.

A communication link that facilitates transmission from the AP 104 to one or more of the STAs may be referred to as a downlink (DL) 108, and a communication link that facilitates transmission from one or more of the STAs to the AP 104 may be referred to as an uplink (UL) 110. Alternatively, a downlink 108 may be referred to as a forward link or a forward channel, and an uplink 110 may be referred to as a reverse link or a reverse channel. In some aspects, DL communications may include unicast or multicast traffic indications.

The AP 104 may suppress adjacent channel interference (ACI) in some aspects so that the AP 104 may receive UL communications on more than one channel simultaneously without causing significant analog-to-digital conversion (ADC) clipping noise. The AP 104 may improve suppression of ACI, for example, by having separate finite impulse response (FIR) filters for each channel or having a longer ADC backoff period with increased bit widths.

The AP 104 may act as a base station and provide wireless communication coverage in a basic service area (BSA) 102. The AP 104 along with the STAs associated with the AP 104 and that use the AP 104 for communication may be referred to as a basic service set (BSS). It should be noted that the wireless communication system 100 may not have a central AP 104, but rather may function as a peer-to-peer network between the STAs. Accordingly, the functions of the AP 104 described herein may alternatively be performed by one or more of the STAs.

The AP 104 may transmit on one or more channels (e.g., multiple narrowband channels, each channel including a frequency bandwidth) a beacon signal (or simply a “beacon”), via a communication link such as the downlink 108, to other nodes (STAs) of the system 100, which may help the other nodes (STAs) to synchronize their timing with the AP 104, or which may provide other information or functionality. Such beacons may be transmitted periodically. In one aspect, the period between successive transmissions may be referred to as a superframe. Transmission of a beacon may be divided into a number of groups or intervals. In one aspect, the beacon may include, but is not limited to, such information as timestamp information to set a common clock, a peer-to-peer network identifier, a device identifier, capability information, a superframe duration, transmission direction information, reception direction information, a neighbor list, and/or an extended neighbor list, some of which are described in additional detail below. Thus, a beacon may include information both common (e.g., shared) amongst several devices, and information specific to a given device.

In some aspects, a STA (e.g., STA 116) may be required to associate with the AP 104 in order to send communications to and/or receive communications from the AP 104. In one aspect, information for associating is included in a beacon broadcast by the AP 104. To receive such a beacon, the STA 116 may, for example, perform a broad coverage search over a coverage region. A search may also be performed by the STA 116 by sweeping a coverage region in a lighthouse fashion, for example. After receiving the information for associating, the STA 116 may transmit a reference signal, such as an association probe or request, to the AP 104. In some aspects, the AP 104 may use backhaul services, for example, to communicate with a larger network, such as the Internet or a public switched telephone network (PSTN).

In one aspect, a STA (e.g., STA 114) may include modules to perform various tasks. For example, the STA 114 may include an information collection module 132 configured to obtain information about the STA 114 and/or information about other devices such as the AP 104. The information collection module 132 may also obtain configuration information from a configuring device. The STA 114 may include an enhanced distributed channel access (EDCA) adjustment module 134 to determine whether to trigger EDCA adjustment based on the obtained information. The EDCA adjustment module 134 may also determine an amount of the EDCA adjustment for each EDCA parameter. In one aspect, the AP 104 may include modules to perform various tasks. For example, the AP 104 may include an information collection module 122 configured to obtain information about the AP 104 and/or information about other devices such as STA 114. The information collection module 122 may obtain configuration information at the AP 104 and/or from other devices. The AP 104 may include an EDCA adjustment module 124 to determine whether to trigger EDCA adjustment based on the obtained information. The EDCA adjustment module 124 may also determine an amount of the EDCA adjustment for each EDCA parameter.

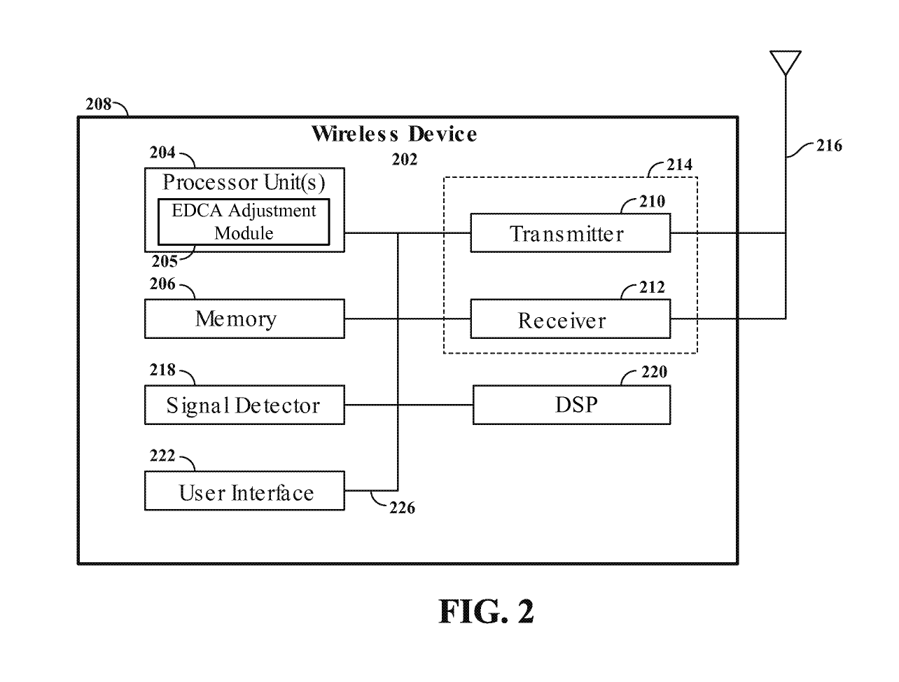

FIG. 2 shows an example functional block diagram of a wireless device 202 that may be employed within the wireless communication system 100 of FIG. 1. The wireless device 202 is an example of a device that may be configured to implement the various methods described herein. For example, the wireless device 202 may comprise the AP 104 or one of the STAs 112, 114, 116, and 118.

The wireless device 202 may include a processor 204 which controls operation of the wireless device 202. The processor 204 may also be referred to as a central processing unit (CPU). Memory 206, which may include both read-only memory (ROM) and random access memory (RAM), may provide instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The processor 204 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 202 may also include a housing 208 that may include a transmitter 210 and/or a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas.

The wireless device 202 may also include a signal detector 218 that may be used in an effort to detect and quantify the level of signals received by the transceiver 214. The signal detector 218 may detect such signals as total energy, energy per subcarrier per symbol, power spectral density and other signals. The wireless device 202 may also include a digital signal processor (DSP) 220 for use in processing signals. The DSP 220 may be configured to generate a packet for transmission. In some aspects, the packet may comprise a physical layer data unit (PPDU).

The wireless device 202 may further comprise a user interface 222 in some aspects. The user interface 222 may comprise a keypad, a microphone, a speaker, and/or a display. The user interface 222 may include any element or component that conveys information to a user of the wireless device 202 and/or receives input from the user.

The processor unit 204 of the wireless device 202 may comprise an EDCA adjustment module 205. For example, the EDCA adjustment module 205 may determine whether to trigger EDCA adjustment based on configuration information received from another device or the node information of the wireless device 202. The EDCA adjustment module 134 may also determine an amount of the EDCA adjustment for each EDCA parameter.

The various components of the wireless device 202 may be coupled together by a bus system 226. The bus system 226 may include a data bus, for example, as well as a power bus, a control signal bus, and a status signal bus in addition to the data bus. Components of the wireless device 202 may be coupled together or accept or provide inputs to each other using some other mechanism.

Although a number of separate components are illustrated in FIG. 2, one or more of the components may be combined or commonly implemented. For example, the processor 204 may be used to implement not only the functionality described above with respect to the processor 204, but also to implement the functionality described above with respect to the signal detector 218 and/or the DSP 220. Further, each of the components illustrated in FIG. 2 may be implemented using a plurality of separate elements.

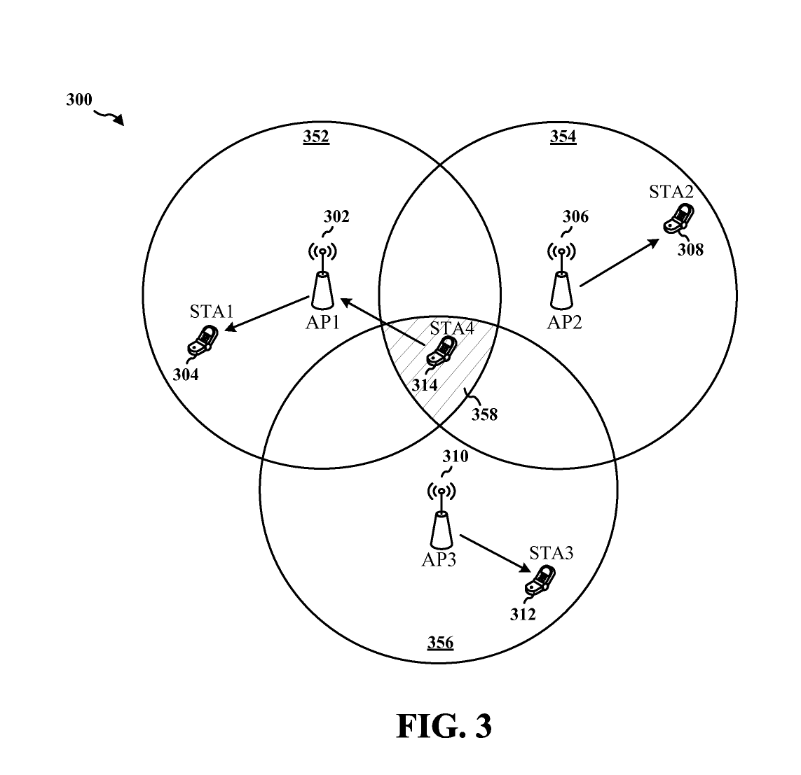

From a channel access perspective, low throughput may be caused by less medium share (e.g., less air time to transmit). For example, low throughput may be due to unfair access to the medium. FIG. 3 is an example diagram 300 illustrating various nodes and their medium sharing. In the example diagram 300 of FIG. 3, there are four traffic transmitting nodes that send out traffic. In particular, access point 1 (AP1) sends traffic to station 1 (STAT) 304 in downlink, access point 2 (AP2) sends traffic to station 2 (STA2) 308 in downlink, and access point 3 (AP3) sends traffic to station 3 (STA3) 312 in downlink. Station 4 (STA4) 314 sends traffic to AP1 302 in uplink. Hence, in FIG. 3, AP1, AP2, AP3, and STA4 are traffic transmitting nodes. AP1 302 having a first coverage area 352 may serve STAT 304. AP2 306 having a second coverage area 354 may serve STA2 308. AP3 310 having a third coverage area 356 may serve STA3 312. In FIG. 3, STA4 314 is located in an overlapping area 358 of the first coverage area 352, the second coverage area 354, and the third coverage area 356. Different traffic transmitting nodes may detect a different set of contenders for the medium and acquire a different medium share. In the example illustrated in FIG. 3, STA4 314 has more neighbor transmitting nodes (e.g., transmitting nodes in proximity with STA4 314) than the other transmitting nodes including AP1 302, AP2 306, and AP3 310. The neighbor transmitting nodes (e.g., AP1 302, AP2 306, and AP3 310) may contend with the STA4 314 for the medium. Thus, STA4 314 may experience less medium usage (MU) due to the presence of more contenders for the medium. Therefore, STA4 314 may be considered a poor performance node (poor node), where a poor performance node is a node having low air time to transmit and thus having low throughput.

Several different approaches are proposed to increase medium usage of a poor node and/or to improve low throughput of the poor node. In a first approach of the disclosure, enhanced distributed channel access (EDCA) aggressiveness may be adjusted to increase the medium usage of poor nodes such that the poor nodes may have increased air time for transmission. The EDCA aggressiveness may be adjusted by adjusting one or more EDCA parameters. In a second approach, a poor node may send an indicator to neighbor nodes to suggest that the neighbor nodes reduce their EDCA aggressiveness. In response, the neighbor nodes may free a portion of the medium to favor the poor node. In the second approach, a neighbor node may ignore the indicator if the neighbor node is a poor node.

In the first approach, EDCA aggressiveness is increased for a poor node in order to increase the poor node's medium usage, thereby improving the poor node's performance. According to the first approach, the following three methods may be utilized.

According to a first method of the first approach, a poor node may autonomously adjust the EDCA aggressiveness of the poor node in order to increase the medium usage (e.g., transmit air time) of the poor node. For example, to satisfy minimum quality of service (QoS), the poor node may increase medium usage by autonomously increasing EDCA aggressiveness of the poor node, with guidance from an access point and/or a network. According to a second method, an access point may cause a poor node to adjust the EDCA aggressiveness of the poor node in order to increase the medium usage (e.g., transmit air time) of the poor node. For example, a poor node may send node information to an access point, where the node information may include the poor node's QoS, medium usage, and/or preferred adjustment. In this example, based on the node information, the access point reconfigures the poor node with more aggressive EDCA parameters. According to a third method, multiple nodes in the network coordinate with each other to increase EDCA aggressiveness of poor nodes. For example, to improve a global X percentile of a node metric across the network, access points may coordinate with each other to jointly identify nodes whose performance metric is below X percentile and may subsequently increase EDCA aggressiveness for the nodes having the performance metric below X percentile, where X is a positive number.

The first method of the first approach may include three configurations. In particular, the first method includes a first configuration with a single stream per node and a second configuration with an extension to multiple streams per node. The first method also includes a third configuration with an extension to multiple access categories across streams.

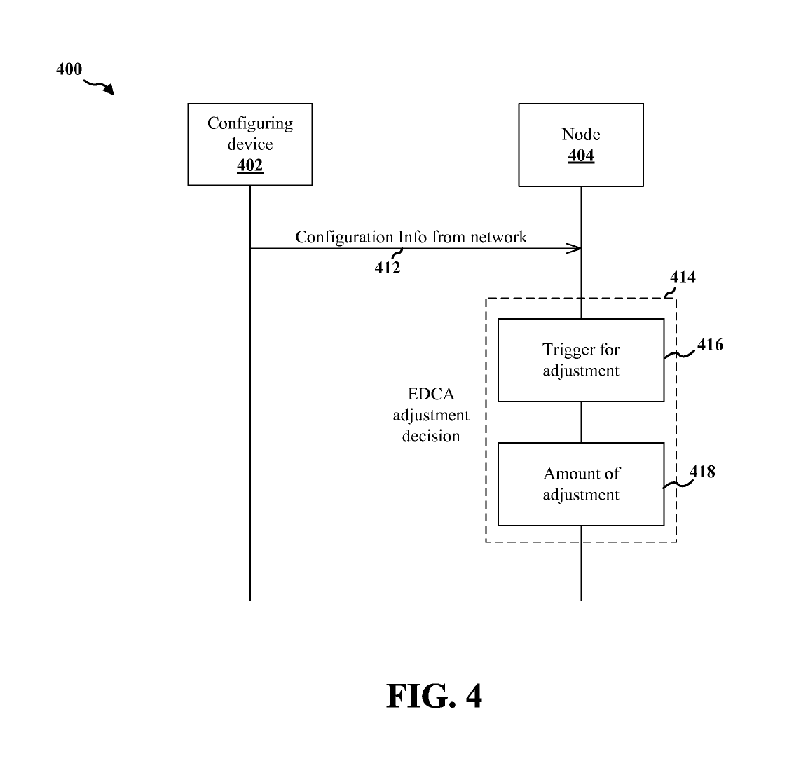

In the first configuration of the first approach's first method, each node has a single traffic stream. It is noted that a node represents a transmitter with its own EDCA parameters, and the node can be an access point or a station. FIG. 4 is an example flow diagram 400 illustrating the first approach's first method. The flow diagram 400 includes a configuring device 402 and a node 404. The configuring device 402 may be located within an access point as a part of a network. The configuring device 402 may obtain configuration information from a network. At 412, the configuring device 402 sends the configuration information to the node 404, in order to configure a decision behavior of the node 404. The configuration information may include a set of triggering conditions for the node 404 to decide to increase or decrease its EDCA aggressiveness and may further include an amount of adjustments for EDCA parameters to be adjusted. Subsequently, at 414, the node 404 makes an EDCA adjustment decision based on the configuration information. In particular, at 416, after receiving the configuration information, the node 404 autonomously triggers adjustment of its own EDCA parameters (e.g., to increase or decrease the EDCA aggressiveness), and at 418, the node 404 determines the amount of the adjustment, based on the configuration information. In one aspect, the node 404 may autonomously trigger adjustment of its own EDCA parameters if the node 404 identifies itself as a poor node.

A node may identify itself as a poor node if a minimum QoS of the node is not satisfied and a minimum medium usage is not satisfied. For example, the minimum QoS is not satisfied when throughput is less than a QoS threshold (e.g., 1 Mbps), and the minimum MU is not satisfied when a percentage of time for transmission is less than a time percentage threshold (e.g., 10%). The QoS threshold and/or the time percentage threshold may be customized in the configuration information.

If the node identifies itself as a poor node, the poor node will then decide to increase its EDCA aggressiveness and will adjust the EDCA parameters in order to increase its EDCA aggressiveness. For example, the poor node may increase the poor node's EDCA aggressiveness for at least one of the EDCA parameters to a next level. The EDCA parameters may include at least one of a minimum contention window (CWmin), a maximum contention window (CWmax), a transmit opportunity duration, or an arbitration inter-frame space number. The EDCA aggressiveness may be increased by decreasing a minimum contention window, decreasing a maximum contention window, increasing a transmit opportunity duration (TXOP), and/or increasing an arbitration inter-frame space number (AIFSN). In one example, a CWmin may be decreased (e.g., from 31 slots to 15 slots) in order to increase the aggressiveness of contention. In such a case, the smaller the CWmin is, the earlier the node will end the node's back-off procedure, thus making the node the more aggressive in accessing the medium. The EDCA aggressiveness may be decreased by increasing a minimum contention window, increasing a maximum contention window, decreasing TXOP, and/or decreasing an AIFSN.

If the minimum QoS and the minimum MU are still not satisfied after a certain time duration (e.g., M ms), the node may adjust the EDCA parameters to further increase the EDCA aggressiveness. The M value may be determined based on the configuration information. Per EDCA parameter, a maximum value or a total increased level limit may be set for stability consideration, such that the EDCA aggressiveness may be increased up to the maximum value or the total increased level limit. For example, it is noted that, if the node becomes too aggressive (e.g., above the maximum value of an EDCA parameter), the network may become unstable. If the minimum QoS and the minimum MU are satisfied for a certain time duration (e.g., for N ms) since a previous adjustment of the EDCA parameter(s), the node may adjust the EDCA parameters to decrease the EDCA aggressiveness to a next level. The N value may be determined based on the configuration information.

In general, a trigger to increase the EDCA aggressiveness may be based on one or more of the following conditions. A first condition may be that the QoS of the node does not satisfy the minimum QoS. A second condition may be that the MU of the node is below the minimum MU threshold. A third condition may be that the QoS or QoS satisfaction metric of the node is worse than a globally poor threshold. The QoS satisfaction metric is defined as a percentage that a minimum QoS is satisfied. For example, the QoS satisfaction metric may be an actual throughput divided by a minimum standard throughput for a corresponding traffic stream of the node. Because different traffic streams may have different minimum QoS requirements, the QoS satisfaction metric provides a normalized metric depending on the minimum QoS requirement of each traffic stream. Thus, in general, if the globally poor threshold is used according to the third condition, a small percentage of nodes with QoS or a QoS satisfaction metric below the threshold are eligible to be more aggressive. In order to maintain network stability, it may not be desirable to have a large percentage of the nodes within a network to be aggressive.

A fourth condition may be that the node's stream is a real time application (e.g., real time voice, real time video, etc.). A real time application may be considered more important in establishing desirable communication latency than a non real time application, and thus it may be more desirable to set the node to be aggressive when the node's stream is a real time application. A fifth condition may be that a ratio of the node's MU to an average neighbor MU is below a threshold. In particular, in order to determine the average neighbor MU, each node may indicate a respective MU in a respective packet (e.g. in SIG field of a packet preamble). Thus, a node can determine a neighbor MU by reading the neighbor node's packet. A sixth condition may be that a request-to-send/clear-to-send (RTS/CTS) mechanism is already enabled. For example, if the node's performance is poor even after enabling the RTS/CTS, it may be desirable to increase the EDCA aggressiveness of the node. A seventh condition may be that a rate supported by a link quality is above a threshold. That is, the EDCA aggressiveness is increased when the link quality is at an acceptable level, which may imply that the poor performance is not due to poor link quality.

A trigger to reduce the EDCA aggressiveness may be based on one or more of several conditions. One example of the conditions for reducing the EDCA aggressiveness is that the QoS of the node is above a certain requirement (e.g., a minimum QoS threshold). For example, if the QoS is sufficient (e.g., above the minimum QoS threshold), then the EDCA aggressiveness may be reduced.

There may be several options for determining an amount of the EDCA adjustment for the EDCA parameters. Options for adjusting the EDCA parameters to increase the EDCA aggressiveness may include at least the following two options. One option is to increase aggressiveness of a set of the EDCA parameters to next O levels, where O may be a different value for each EDCA parameter. Thus, the EDCA aggressiveness may be gradually (e.g., incrementally) increased as the EDCA parameters are incrementally adjusted to O levels. The O value may be included in the configuration information. Another option is to reconfigure the EDCA parameters to fixed values with increased EDCA aggressiveness (e.g., 1-step adjustment). For example, the EDCA aggressiveness may be increased in a one-step adjustment as the EDCA parameters are increased to the respective fixed values. Options for reducing EDCA aggressiveness may include at least the following two options. One option is to reduce the EDCA aggressiveness of a set of parameters to next P levels, where P may be a different value for each EDCA parameter. Thus, the EDCA aggressiveness may be gradually decreased as the EDCA parameters are incrementally adjusted to respective P levels. The P value for each EDCA parameter may be included in the configuration information. Another option is to immediately restore the EDCA parameters to original values.

The configuration information is explained more in detail below. The configuring device (e.g., the configuring device 402) sends configuration information to each node (e.g., the node 404) to configure the node's decisions/actions for autonomous EDCA adjustment. The configuring device may be a network server or an access point. The configuration information used for a node to trigger the EDCA aggressiveness increase may include a minimum QoS threshold, a minimum MU threshold, and a globally poor threshold. For example, the minimum QoS threshold may be 1 Mbps throughput, and the QoS metric may be at least one of throughput, average packet delay, a packet error rate (PER), and etc. The minimum MU threshold may be, for example, 10% time for transmission. Options for the globally poor threshold are explained infra. The configuration information used for a node to trigger EDCA aggressiveness reduction may include a high QoS threshold (e.g., 5 Mbps throughput). If the node has a throughput above the high QoS threshold, the node's throughput is sufficient and thus the EDCA aggressiveness may be reduced.

The configuration information of the EDCA parameters that are to be adjusted and the adjustment amount of the EDCA parameters may include information based on at least one of the following options. In one option, the configuration information may include the EDCA parameters, and a number of levels to be increased/reduced per EDCA parameter. Thus, the configuration information may include information for determining which EDCA parameter to adjust and an adjustment amount for such EDCA parameter. According to another option, the configuration information may include the EDCA parameters and respective fixed values for increasing EDCA aggressiveness. Both or either of the above options may also specify a maximum value or a maximum total increased level number for each EDCA parameter, placing a cap on maximum EDCA aggressiveness. Further, the configuration information may include information of timers for deciding to readjust the EDCA parameters, where timer values represent how frequently the EDCA parameters are readjusted. The timers may be used to readjust the EDCA aggressiveness based on the following options. In one option, the configuration information may include a timer value of Q ms to decide whether to further increase EDCA aggressiveness, where Q is a positive number. For example, the node may decide to increase the EDCA aggressiveness when the timer of Q ms expires. In another option, the configuration information may include a timer value of R ms to decide whether to reduce EDCA aggressiveness, where R is a positive number. For example, the node may decide to reduce the EDCA aggressiveness when the timer of R ms expires.

As discussed supra, the node may increase EDCA aggressiveness of the node if the node's QoS or QoS satisfaction metrics is worse than a globally poor performance threshold. The globally poor threshold may be defined based on at least one of the following options. In a first option, the globally poor threshold can be X percentile of the QoS or the QoS satisfaction metrics of all streams within the BSS. Thus, if a node is below the X percentile for the QoS or the QoS satisfaction metric, then the node is eligible for increasing the EDCA aggressiveness. For example, the QoS may be based on at least one of a throughput, an average packet delay, PER, etc. For example, the QoS satisfaction metric for each stream may be a ratio of a stream throughput to a minimum standard throughput for the stream. To further illustrate the concept, for example, it is assumed that a BSS has 20 nodes with each node transmitting a stream. In such an example, the 20 nodes have their QoS satisfaction metrics computed and sorted in ascending order as 0.05, 0.1, 0.15, 0.2, 0.25, . . . , 1.0 with an increment step of 0.05. If X=10, the corresponding 10 percentile of the QoS satisfaction metrics of all 20 streams in the BSS is 0.1 because 0.1 corresponds to the 10 percentile of the 20 QoS values. Hence, the nodes with QoS satisfaction metrics of 0.05 and 0.1, respectively, fall below the 10 percentile of the 20 QoS values. Therefore, only these two nodes whose QoS satisfaction metrics fall below the 10 percentile of the 20 QoS values are eligible to increase their EDCA aggressiveness.

In a second option, the globally poor threshold may be the worst X percentile among the node's BSS and neighbor BSSs. Similarly to the first option, each BSS first determines its own X percentile number of the QoS or the QoS satisfaction metrics of all streams within its BSS, where the X percentile number is the QoS or the QoS satisfaction metrics corresponding to the X percentile. Among all X percentile numbers of the BSSs, the worst X percentile is selected as the globally poor threshold. If a node is below the worst X percentile, then the node is eligible for increasing its EDCA aggressiveness. To illustrate the concept, for example, it is assumed that a BSS have 5 neighbor BSSs with X=10 percentile numbers of the BSS and the 10 percentile numbers (e.g., QoS satisfaction metrics corresponding to 10 percentile) of the 5 neighbor BSSs are 0.1, 0.2, 0.3, 0.4, 0.5, 0.6, respectively. In such an example, the X percentile number (e.g., QoS satisfaction metric corresponding to X percentile) of each BSS can be computed as the example illustrated in the first option. The BSS then selects the worst X percentile number (0.1, in this example) among the X percentile numbers of the node's BSS and neighbor BSSs as the globally poor threshold, and the nodes in this BSS with QoS or QoS satisfaction metrics below the globally poor threshold are eligible to increase their EDCA aggressiveness. To determine the worst X percentile number, if the configuring device is an access point, each access point can broadcast the X percentile number of its BSS and determine the worst X percentile number by requesting a station served by the access point to report the X percentile numbers broadcasted by respective neighbor access points of their respective BSSs. Thus, an access point that is a configuring device may determine the worst X percentile number among its own X percentile number of the access point and X percentile numbers of neighbor access points.

In another aspect of the second option, the globally poor threshold may be determined by selecting S worst X percentile numbers and then selecting the largest X percentile number among the S worst percentile numbers, where S is a positive number. For example, if S is three, three worst X percentile numbers may be obtained, and then the largest number of the three worst percentile numbers may be used as the globally poor threshold. In one example, if X percentile numbers of the 5 neighbor BSSs are 0.1, 0.2, 0.3, 0.4, 0.5, 0.6, respectively, and S is three, three worst X percentile numbers are 0.1, 0.2, and 0.3. In this example, the largest number of the three worst X percentile numbers is 0.3, which is used as the globally poor threshold. After determining the globally poor threshold, the access point may send the globally poor threshold to the autonomous node (e.g., node 404) to inform the autonomous node of the globally poor threshold.

In a third option, the globally poor threshold can be X percentile of the QoS or the QoS satisfaction metrics of all streams in a BSS and neighbor BSSs. Thus, according to the third option, a BSS considers the streams from the BSS and its neighbor BSSs to determine X percentile. To determine X percentile, an access point in a BSS may retrieve QoS or QoS satisfaction metrics of all streams per neighbor BSS, which can be obtained from neighbor access point via OTA relay using a station or via backhaul exchange, and may also retrieve QoS or QoS satisfaction metrics of all streams of its own BSS. For example, if the stations report 50 QoS or QoS satisfaction metrics values for each BSS, and if there are four BSSs, then the BSS considers total 200 (50×4) values to determine X percentile.

In the above options, X percentile can be based on an absolute stream QoS (e.g., throughput, delay, PER, etc.). However, different types of traffic streams may have different minimum QoS requirements (e.g., different minimum throughputs). Thus, the node's absolute stream QoS may not reflect whether the absolute stream QoS satisfies a corresponding QoS requirement. That is, the QoS may be normalized based on different minimum QoS requirements to better reflect the node's satisfaction with the QoS of the node. Thus, a QoS satisfaction metric per stream may be defined as the percentage that the minimum QoS is satisfied. For example, if the QoS is a throughput, the QoS satisfaction metric may be a ratio of an actual stream throughput to the minimum throughput for the stream, where the ratio of less than 1 indicates an unsatisfactory result. Then, X percentile is computed based on the ratio. For example, for each cell, if there are 50 throughput numbers and thus corresponding to 50 ratios, then nodes that have ratios below the X percentile based on the 50 ratios may be determined. X percentile and the globally poor threshold in the first, second, and third options discussed supra may be computed based on the QoS satisfaction metric instead of the absolute QoS value. In such a case, a node may increase the EDCA aggressiveness of the node if the node's QoS satisfaction metric is worse than the globally poor threshold.

In an example according to the first option above, if a BSS has 50 streams corresponding to 50 throughputs, then the nodes with throughput values under X percentile are considered to have an unsatisfactory throughput. For example, if X percentile of the nodes has a throughput of below 3 Mbps, then the EDCA aggressiveness for the nodes below 3 Mbps are increased. When the QoS satisfaction metric is used, instead of considering the throughput itself, the ratio of the actual throughput to the minimum throughput is considered for each stream. If the BSS has 50 streams corresponding to 50 ratios, then the nodes with ratio values under X percentile are considered to have an unsatisfactory throughput, and thus the EDCA aggressiveness for such nodes are increased.

In the second configuration of the first approach's first method, each node may transmit multiple traffic streams. The method for the second configuration may depend on at least one of the following scenarios. According to a first scenario of the second configuration, a single set of EDCA parameters is used for all streams per node. The first scenario further assumes that the node optimizes MU allocation among streams to maximize the worst stream QoS satisfaction metric. For example, the node provides more access opportunities to the worst stream (among multiple streams per node) to improve its QoS satisfaction metric. The algorithm in the first configuration may be modified to create an algorithm for the first scenario of the second configuration to examine the QoS and the QoS satisfaction metric of the steam with the worst QoS satisfaction metric in an EDCA adjustment trigger (e.g., the first and third conditions to trigger an increase the EDCA aggressiveness, as discussed above). In the first configuration, because every node has only one stream, a node determines that it is a poor node by determining whether the QoS is below the minimum QoS requirement and/or whether the QoS satisfaction metric is below the globally poor threshold. In the second configuration where each node has multiple streams, the node decides that the node is a poor node if the QoS of the stream with the worst QoS satisfaction metric is below the minimum QoS requirement and/or the worst QoS satisfaction metric is below the globally poor threshold.

According to a second scenario of the second configuration, a single set of EDCA parameters is used for each of multiple streams per node. Thus, each of the multiple streams transmitted by a node corresponds to its own set of EDCA parameters. In the second scenario, the algorithm for the second scenario of the second configuration is similar to the first configuration in that each of the multiple streams is treated independently from each other, where the first configuration treats each stream as a stream from an independent node. Thus, each stream is associated with an independent EDCA adjustment decision based on the stream's QoS (or QoS satisfaction metric) and other metrics that are used in EDCA adjustment triggers.

In a third configuration of the first approach's first method, multiple access categories (AC) exist per node. In one example, there may exist four access categories with different sets of EDCA parameters for different access priorities. The access categories may include access category voice (AC_VO), access category video (AC_VI), access category better-effort (AC_BE), and access category background (AC_BK). A node may transmit multiple streams per AC with corresponding values of the EDCA parameters. In this case, a set of EDCA parameters for each AC per node may be adjusted based on an algorithm similar to the algorithm in the first scenario of the second configuration, but with the following modifications. Each node may include multiple access categories (e.g., four access categories), and each access category may have respective values for the EDCA parameters. For example, if there are four access categories, there are four sets of values for the EDCA parameters respectively corresponding to the four access categories. Thus, each AC per node may be treated similar to an independent node of the first scenario of the second configuration. That is, each AC per node is treated as a virtual independent node, for example. Each AC per node is associated with an independent EDCA adjustment decision. For each AC, there may be multiple streams per AC. The MU and the worst stream QoS satisfaction metric and the corresponding QoS of each AC on the node are used as EDCA adjustment trigger inputs. The configuration information may be provided per AC to differentiate adjustment behavior depending on the AC. For example, an AC with a higher priority may have a more prompt EDCA adjustment trigger (e.g., a faster trigger), a larger adjustment step size (e.g., a larger amount of adjustment), and/or a shorter readjustment timer value (e.g., readjust more frequently), etc.

The configuration information from the configuring device may include the following: configuration information to trigger increasing/reducing EDCA aggressiveness, which may include a “globally poor” performance threshold; configuration information of EDCA parameters to be adjusted and an adjustment amount; and configuration information of timers to decide whether to readjust EDCA aggressiveness. Such information may be sent in OTA frames if the configuring device is an AP and the node is a station. The OTA frames may include beacon frames, probe/association response frames, and unicast/multicast management frames. In one case, the configuring device may be an AP and the globally poor threshold may be defined as the worst X percentile of stream QoS or a QoS satisfaction metric in the AP's BSS and neighbor BSSs. In such a case, each AP can first broadcast X percentile of QoS or QoS satisfaction metrics of all streams in a respective BSS. Subsequently, each AP determines the worst X percentile by requesting a STA of a respective AP to report X percentile broadcasted by neighbor APs. Thus, an AP may determine the worst X percentile number (X percentile of QoS or QoS satisfaction metric) among its own X percentile number of the AP and X percentile numbers of neighbor APs.

In the second method of the first approach, the AP makes the decision for EDCA adjustment. In a first configuration of the first approach's the second method, it is first assumed that each node has a single traffic stream. A node represents a transmitter having EDCA parameters. In the second method, a node mainly refers to a station with UL traffic. AP's EDCA adjustment decision procedure may be similar to the EDCA adjustment decision procedure of the autonomous method according to the first method.

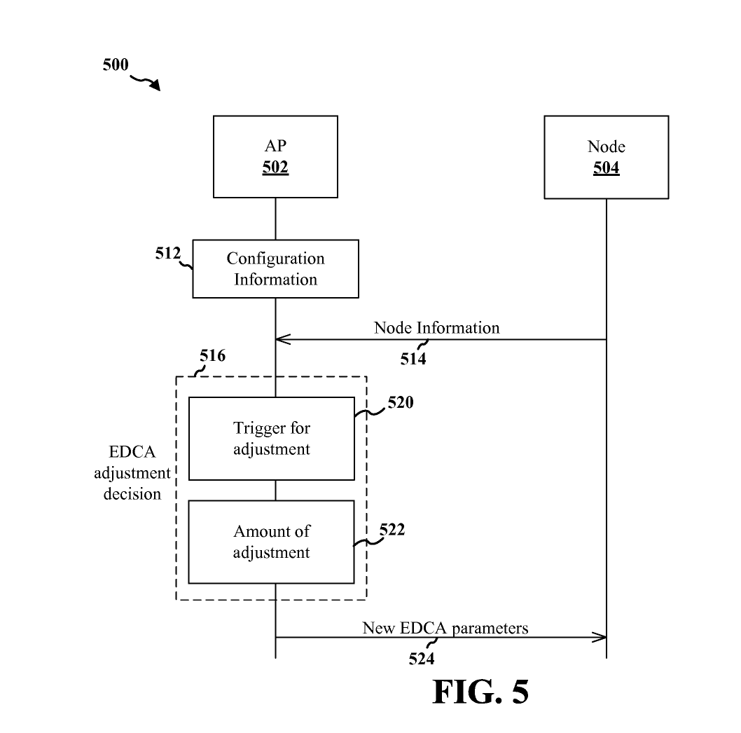

FIG. 5 is an example flow diagram 500 illustrating the first approach's second method. An AP 502 first obtains configuration information for EDCA adjustment decision at 512. The configuration information in the second method may contain the same information as the configuration information in the autonomous method of the first method as described supra. The configuration information is set by a configuring device, which may be the AP 502 itself, a network server, or another AP. Thus, the configuration information may be determined by the AP 502 itself, or may be determined by a network server or another AP and sent to the AP 502. The AP 502 may receive from a node 504 node information about the node 504 at 514. Subsequently, at 516, the AP 502 makes an EDCA adjustment decision based on the configuration information and the node information. In particular, at 518, the AP 502 triggers at 520 adjustment of the EDCA parameters (e.g., to increase or decrease EDCA aggressiveness of the node 504), and at 522, the AP 502 determines an amount of the EDCA adjustment, based on the configuration information and the node information from the node 504. The EDCA adjustment decision in the second method follows similar decision rules and inputs as in the autonomous method of the first method. Finally, at 524, the AP 502 sends the EDCA parameters representing the decided EDCA adjustment to the node 504.

An AP may identify that a node is a poor node based on information from the node. If the AP identifies that the node is a poor node, the AP increases the poor node's EDCA aggressiveness. As an example, a node is poor if the node's minimum QoS and minimum MU requirements are not satisfied. Referring back to FIG. 5, according to a basic example, the node 504 may send node information including the node's MU to the AP at 514. During the EDCA adjustment decision 516, if the AP 502 detects that the node 504 is still poor after certain time duration (e.g., M ms), the AP 502 triggers at 520 adjustment of the EDCA parameters to further increase the EDCA aggressiveness. During the EDCA adjustment decision 516, if the AP 502 detects that the minimum QoS and the minimum MU requirements are satisfied after certain time duration (e.g., N ms), the AP 502 triggers at 520 adjustment of the EDCA parameters to decrease the node's EDCA aggressiveness. After the EDCA adjustment decision 516, the AP 502 sends at 524 new EDCA parameters representing the determination during the EDCA adjustment decision 516.

To determine whether to trigger to increase the node's EDCA aggressiveness, an AP considers the following node inputs (node information) from the node. The node inputs include the node's MU. The node inputs may include QoS, if the AP does not measure the QoS. The node inputs may further include an MU per neighbor node, or statistics of neighbor nodes' MUs (e.g., an average neighbor MU) if information on the neighbor node's MU is used in an adjustment trigger. Signaling options to collect the node's information are described infra.

To configure a decision behavior, the AP utilizes configuration information, which may be set by the AP itself, another AP, or a network server. In particular, the configuration information may include a globally poor threshold to evaluate a trigger for increasing the EDCA aggressiveness. The determination of globally poor threshold is similar to the first approach's first method (autonomous adjustment). In one case, the globally poor threshold is set by the AP itself and may be defined as the worst X percentile of stream QoS or a QoS satisfaction metric in a BSS and neighbor BSSs. In such a case, each AP (e.g., each of the AP and the neighbor APs) can first broadcast X percentile of QoS or a QoS satisfaction metrics of all streams in a respective BSS. Subsequently, in such a case, each AP determines the worst X percentile by requesting a respective station to report X percentile broadcasted by neighbor APs. Thus, an AP may determine the worst X percentile number (X percentile of QoS or QoS satisfaction metric) among its own X percentile number of the AP and X percentile numbers of neighbor APs.

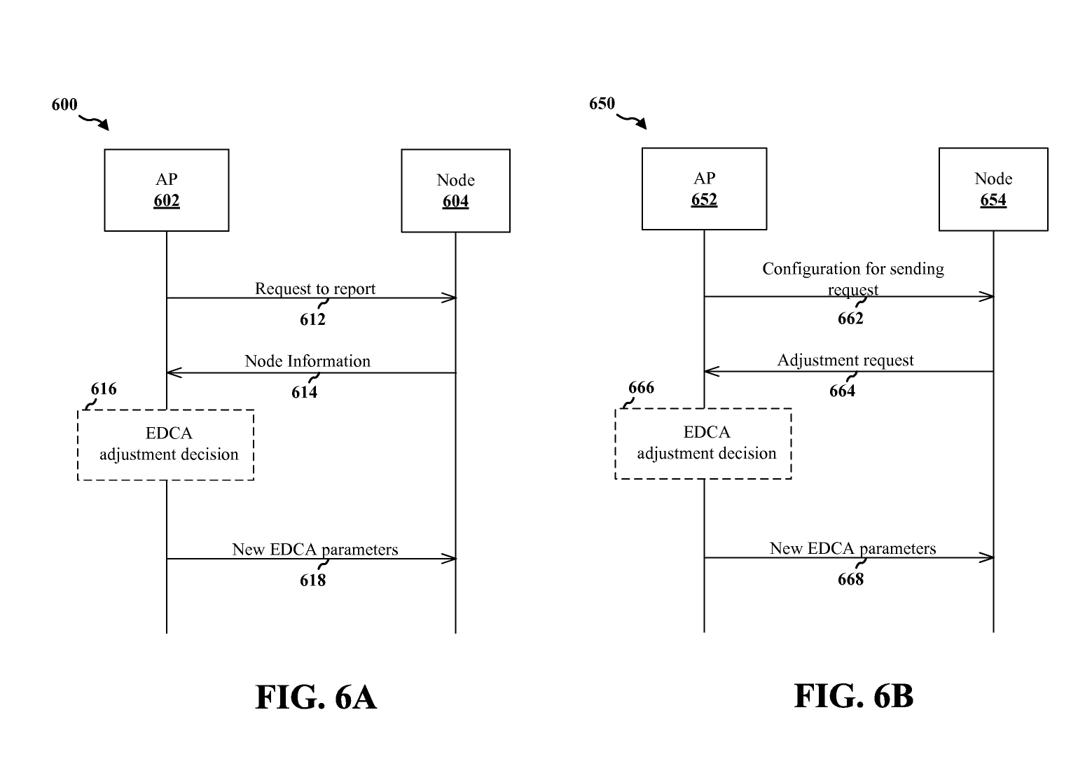

Additional signaling in addition to the signaling illustrated in FIG. 5 may be used to collect node information of the node, such that the AP may use the node information to make a decision on the EDCA aggressiveness. The following options for signaling may be used. In a first option, the AP requests a node to report the node information. FIG. 6A is an example flow diagram 600 illustrating the first option of the additional signaling. The flow diagram 600 includes an AP 602 and a node 604. The AP 602 and the node 604 may respectively correspond with the AP 502 and the node 504 of FIG. 5. The AP 602 requests the node 604 at 612 to report the node information if increasing node's EDCA aggressiveness may be needed. For example, if the AP 602 determines that the throughput is below a minimum throughput, the AP 602 will request the node to report the node information such as the node's MU. The AP 602 may send the request to the node periodically or whenever the AP 602 detects that node's QoS does not satisfy the minimum QoS requirement. In response to the request, the node 604 sends the node information to the AP 602 at 614. The node information includes the node's MU. The node information may also include QoS, if the AP 602 does not measure QoS itself. Based on the received node information, the AP 602 decides the EDCA parameters at 616 and sends the decided parameters to the node at 618. It is noted that the EDCA adjustment decision performed at 616 may correspond with the EDCA adjustment decision at 516 of FIG. 5

In a second option, the node initiates reporting of the node information. FIG. 6B is an example flow diagram 650 illustrating the first option of the additional signaling. The flow diagram 650 includes an AP 652 and a node 654. The AP 652 and the node 654 may respectively correspond with the AP 502 and the node 504 of FIG. 5. According to the second option, the AP 652 first sends a configuration message to the node 654 at 662 with conditions that are considered in determining whether to send an adjustment request. The conditions may be conditions for triggering the EDCA adjustment, as in the autonomous method. If the conditions are satisfied, the node 654 sends EDCA adjustment request to the AP 652 at 664, instead of making adjustments autonomously. The EDCA adjustment request may include node's MU and QoS. The EDCA adjustment request may include an indicator for increase or decrease EDCA aggressiveness, and/or preferred new EDCA parameters. Then, based on the received adjustment request, the AP 652 decides the EDCA parameters at 666 and sends the decided parameters to the node 604 at 668. It is noted that the EDCA adjustment decision performed at 666 may correspond with the EDCA adjustment decision at 516 of FIG. 5

In the second configuration of the first approach's second method, each node can transmit multiple traffic streams. Decision rules are similar to the decision rules of the autonomous adjustment of the first method. According to a first scenario of the second configuration, a single set of EDCA parameters is used for all streams per node. In the first scenario of the second configuration, the algorithm in the first configuration may be modified to examine the worst stream QoS satisfaction metric in an EDCA adjustment trigger. Thus, the algorithm for the first scenario of the second configuration is similar to the algorithm for the first scenario of the second configuration in the autonomous adjustment of the first method. According to a second scenario of the second configuration, a single set of EDCA parameters is used for each of multiple streams per node. In the second scenario, the algorithm for the second scenario of the second configuration is similar to the algorithm for the first configuration in that each of the multiple streams is treated independently from each other, where the first configuration treats each stream as a stream from an independent node. The AP makes independent EDCA adjustment decision for each stream based on the stream's QoS and other metrics. It is noted that the node reports MU per stream to the AP.

In a third configuration of the first approach's second method, multiple access categories (AC) exist per node. The algorithm is similar to the algorithm for the third configuration in the autonomous adjustment of the first method, except that AP makes the EDCA adjustment decision. In an aspect, there are 4 access categories with different sets of EDCA parameters for different access priorities. The access categories may include access category voice (AC_VO), access category video (AC_VI), access category better-effort (AC_BE), and access category background (AC_BK). A node may transmit multiple streams per AC with corresponding values of the EDCA parameters. In this case, a set of EDCA parameters for each AC per node may be adjusted based on an algorithm similar to the algorithm in the first scenario of the second configuration, but with the following modifications. Each node may include multiple access categories (e.g. four access categories), and each access category may have respective values for EDCA parameters. Thus, each AC per node is treated similarly to an independent node of the first scenario of the second configuration. That is, each AC per node is treated as a virtual independent node, for example. Each AC per node has independent EDCA adjustment decision. The node reports MU and worst stream QoS satisfaction metric and the corresponding QoS of each AC per node to the AP as EDCA adjustment trigger inputs. The configuration information may be provided per AC to differentiate adjustment behavior depending on the AC. For example, an AC with a higher priority may have a more prompt EDCA adjustment trigger (e.g., a faster trigger), a larger adjustment step size (e.g., a larger amount of adjustment), and/or a shorter readjustment timer value (e.g., readjust more frequently), etc.

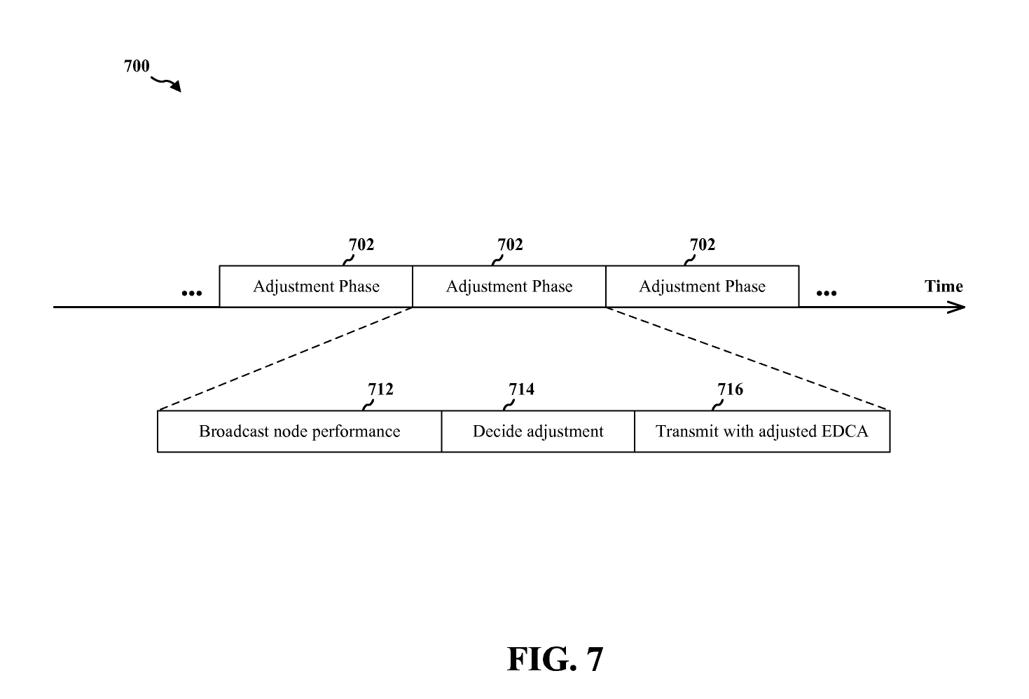

A third method of the first approach may be used for a coordinated EDCA adjustment for poor nodes. In particular, multiple APs may coordinate together to identify poor nodes across the entire network, and to jointly make EDCA adjustments for the poor nodes accordingly, based on a time schedule. Then, the APs check whether the performance of the poor nodes is improved across the entire network after the EDCA adjustments. The APs may coordinate on a sequence of EDCA adjustment phases. FIG. 7 is an example diagram 700 illustrating a time line of EDCA adjustment phases. The time line in FIG. 7 has multiple adjustment phases 702. Each adjustment phase 702 has the following three periods, a first period 712, a second period 714, and a third period 716. The first period 712 is for broadcasting node performance. In the first period 712, each AP propagates a respective served node performance metrics to other APs. The second period 714 is for deciding EDCA adjustment. In the second period 714, based on node metrics from all APs, each AP attempts to improve global X percentile by adjusting EDCA aggressiveness for a set of respective nodes. For example, each AP broadcasts throughput for respective stations, and thus every AP knows individual throughput of the stations in the network, and each AP computes global X percentile across all throughput numbers in the network. If an AP determines that there are nodes per AP that fall below the global X percentile, the AP adjusts the EDCA aggressiveness for such nodes. The third period 716 is for transmitting with adjusted EDCA. In the third period 716, adjustment is applied in DL and UL transmissions, and the AP collects node performance metrics (e.g., throughput) measured in this period for next broadcast.

During the first period 712, the AP gathers node metrics per BSS in the network. The node metric may be throughput, an average packet delay, average medium usage (MU), PER, a retry rate, or a QoS satisfaction metric defined as an actual throughput divided by a minimum standard throughput, etc. Node metrics per BSS can be in a form of a cumulative distribution function (CDF). The metric collection can be performed via AP broadcast and a node report, inter-AP communications, and/or a network server. Thus, each AP may learn other APs' metrics.

During the second period 714, the AP decides whether to make the EDCA adjustment, and an amount of the EDCA adjustment. In particular, the AP gathers the node metrics in the network, computes global X percentile, and decides EDCA for nodes falling in X percentile of the node metrics based on the following logic. If an X percentile number (a node metric for X percentile) is below threshold 1 (minimum requirement), the EDCA aggressiveness is increased to next level for nodes in X percentile of the node metrics. There is no further increase in the EDCA aggressiveness if EDCA reaches maximum value or maximum iteration number. If X percentile number becomes worse, the AP revokes a previous EDCA adjustment and/or a decision not to further increase. If the X percentile number is greater threshold 2, then the EDCA aggressiveness is decreased to a next level for nodes in X percentile of the node metrics. Threshold 2 may be greater than threshold 1. There is no further decrease in the EDCA aggressiveness if the EDCA aggressiveness reaches initial default value. If X percentile is greater than or equal to threshold 1 and is less than or equal to threshold 2, then AP decides to make no changes in the EDCA aggressiveness.

During the third period 716, nodes use adjusted EDCA for transmission. EDCA adjustments are not made in the third period for performance measurement. The AP collects node performance metrics in the third period for a next broadcast.

In the third method of the first approach, the AP uses coordination messages (e.g., a time schedule) for timing the adjustment phases. The coordination messages are exchanged among the APs or sent to the APs from a control device or a network server. For example, a time schedule is used for adjustment phases and internal periods. For each adjustment phase, the time period needs to be aligned among the APs. Further, in the third method, broadcast messages include a CDF of node metric (e.g., node throughput) per BSS and/or global X percentile of node metric. Thus, each AP knows other APs' node metrics, and computes the global X percentile based on the other APs' node metrics.

Applicable to the first, second, and the third methods, an AP may utilize an indicator of supporting EDCA parameter adjustment per individual station. With regard to signaling at the AP side, the AP may send the indicator in a beacon, probe/association response. The indicator may also help a station make a decision to enable other mechanisms. For example, a station may enable RTS/CTS to jointly work with the EDCA adjustment to improve both PER and medium usage. If multiple modes are available at the AP, the AP may signal supported EDCA adjustment modes, where the supported EDCA adjustment modes include, for example, an autonomous mode, an AP-controlled mode, or a coordinated EDCA adjustment mode. With regard to signaling at the station side, a station may utilize an indicator of supporting autonomous EDCA adjustment. The station may send the indicator to the AP in a probe/association request. After the station is associated with the AP, if the AP and the station can support the autonomous EDCA adjustment, the AP will send configuration information to the station.

The second approach of the disclosure adjusts the EDCA aggressiveness of neighbor nodes, as briefly discussed supra. In the second approach, the EDCA aggressiveness for neighbor nodes of a poor node is reduced in order to increase the poor node's medium usage and hence performance of the poor node. Such feature may be achieved according to the following two methods. According to a first method of the second approach, a poor node may autonomously instruct the neighbor nodes to adjust the EDCA aggressiveness on an EDCA adjustment indicator (e.g., a 1-bit EDCA indicator) in order to increase medium usage (e.g., transmit air time) of the poor node. For example, to satisfy minimum QoS, the poor node may increase the medium usage of the poor node by autonomously sending an indicator to neighbor nodes suggesting the neighbor nodes to reduce their EDCA aggressiveness, with some guidance from AP and/or a network. According to a second method, an access point may cause a poor node to instruct the neighbor nodes to adjust the EDCA aggressiveness based on an EDCA adjustment indicator (e.g., 1-bit EDCA indicator) in order to increase medium usage (e.g., transmit air time) of the poor node. For example, a poor node may send node information to an access point with the poor node's QoS, medium usage, and/or preferred adjustment, based on which the AP instructs the poor node to send an indicator to the neighbor nodes suggesting the neighbor nodes to reduce their EDCA aggressiveness. It is noted that, in order to help neighbor nodes make a decision, the indicator may include detailed information, including identifiers of a subset of neighbor nodes consuming the most medium, poor node's metrics and traffic type, detailed adjustment suggestion, etc. The first method of the second approach may include three configurations, as discussed infra.

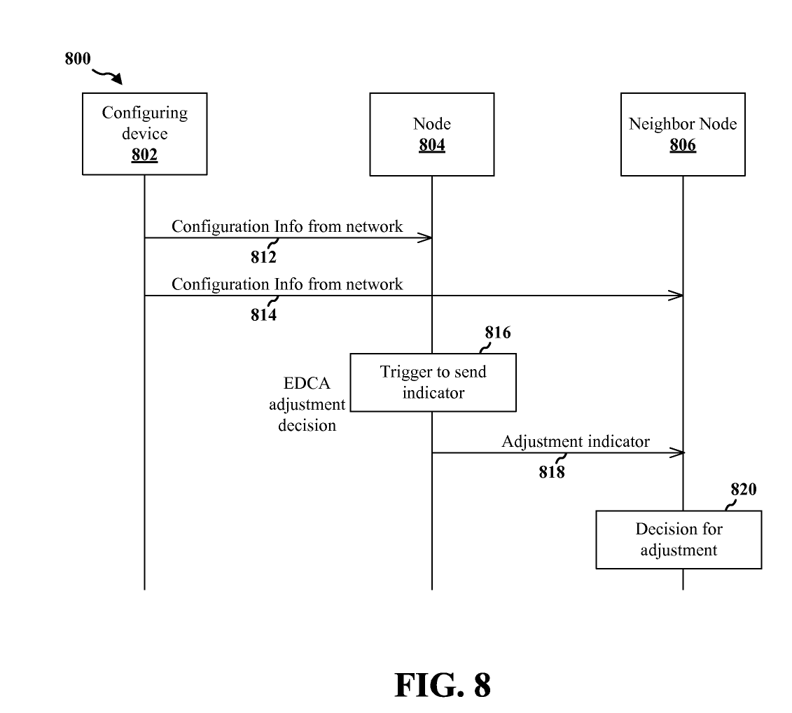

In the first configuration of the second approach's first method, each node has a single traffic stream. It is noted that a node represents a transmitter having EDCA parameters, and can be an access point or a station. FIG. 8 is an example flow diagram 800 illustrating the second approach's first method. The flow diagram 800 includes a configuring device 802, a node 804, and a neighbor node 806. The configuring device 802 may be located within an access point as a part of a network. The configuring device 802 sends at 812 configuration information from a network to the node 804, and also sends at 814 the configuration information to the neighbor node 806, in order to configure decision behaviors of the node 804 and the neighbor node 806, respectively. The configuration information may include a trigger to increase or decrease EDCA parameter aggressiveness and an amount of adjustment. At 816, after receiving the configuration information, the node 804 triggers to send an EDCA adjustment indicator of the EDCA parameters of the neighbor node 806 (e.g., to increase or decrease the EDCA aggressiveness of the neighbor node 806). Upon the trigger to send the EDCA adjustment indicator, at 818, the node 804 autonomously sends the EDCA adjustment indicator 818 to the neighbor node 806, and at 820, the neighbor node 806 determines the amount of the adjustment, based on the configuration information.

If a minimum QoS of the node is not satisfied and a minimum medium usage is not satisfied, a node may identify itself as a poor node and send its neighbor node an EDCA adjustment indicator (e.g., in packets) to reduce EDCA aggressiveness of the neighbor node. For example, the minimum QoS is not satisfied when throughput is less than a QoS threshold (e.g., 1 Mbps), and the minimum MU is not satisfied when a percentage of time for transmission is less than a time percentage threshold (e.g., 10%). The QoS threshold and/or the time percentage threshold may be customized.

If the neighbor node receives the EDCA adjustment indicator to reduce the EDCA aggressiveness, the neighbor node will then adjust the EDCA parameters to reduce its EDCA aggressiveness. For example, the neighbor node may reduce the neighbor node's EDCA aggressiveness of at least one of the EDCA parameters to a next level based on the EDCA adjustment indicator. The EDCA parameters may include at least one of a CWmin, a CWmax, a transmit opportunity duration, or an arbitration inter-frame space number. The EDCA aggressiveness may be reduced by increasing a minimum contention window, increasing a maximum contention window, decreasing a transmit opportunity duration, and/or decreasing an arbitration inter-frame space number. In one example, a CWmin may be increased (e.g., from 15 slots to 31 slots) in order to reduce the aggressiveness of contention. In such a case, the greater the CWmin is, the later the neighbor node will end the neighbor node's back-off, thus making the node less aggressive.

If the neighbor node continues to receive the EDCA adjustment indicator to reduce the EDCA aggressiveness after a certain time duration (e.g., M ms), the neighbor node may adjust the EDCA parameters to further reduce the EDCA aggressiveness of the neighbor node. The M value may be determined based on the configuration information. Per EDCA parameter, a minimum value or a total decreased level limit may be set for stability consideration, such that the EDCA aggressiveness may be reduced up to the minimum value or the total decreased level limit. If the neighbor node stops receiving the EDCA adjustment indicator to reduce the EDCA aggressiveness after certain time duration (e.g., for N ms) since a previous adjustment of the EDCA parameter(s), the neighbor node may adjust the EDCA parameters to gradually or immediately increase the EDCA aggressiveness to the original setting. The N value may be determined based on the configuration information.

A trigger to reduce the EDCA aggressiveness may be based on one or more of the following conditions. A first condition may be that the QoS of the node does not satisfy the minimum QoS. A second condition may be that the MU of the node is below the minimum MU threshold. A third condition may be that the QoS or a QoS satisfaction metric of the node is worse than a globally poor threshold. The QoS satisfaction metric is defined as a percentage that a minimum QoS is satisfied. For example, the QoS satisfaction metric may be an actual throughput divided by a minimum standard throughput. Because different traffic streams may have different minimum QoS requirements, the QoS satisfaction metric provides a normalized metric depending on the minimum QoS requirement of each traffic stream. Thus, in general, if the globally poor threshold is used according to the third condition, a small percentage of nodes with QoS or QoS satisfaction metric below the threshold are eligible to be more aggressive. It may not be desirable to have a large percentage of the nodes within a network to be aggressive.

A fourth condition may be that the node's stream is a real time application (e.g., real time voice, real time video, etc.). A real time application may be considered more important in establishing desirable communication latency than a non real time application, and thus it may be more desirable to set the node to be aggressive when the node's stream is a real time application. A fifth condition may be that a ratio of the node's MU to an average neighbor MU is below a threshold. In particular, in order to determine the average neighbor MU, each node may indicate a respective MU in a respective packet (e.g. in SIG field of a packet preamble). Thus, a node can determine a neighbor MU by reading the neighbor node's packet. A sixth condition may be that RTS/CTS is already enabled. For example, if the node's performance is poor even after enabling the RTS/CTS, it may be desirable to increase the EDCA aggressiveness of the node. A seventh condition may be that a rate supported by a link quality is above a threshold. That is, the EDCA aggressiveness is increased when the link quality is at an acceptable level.

A trigger for a neighbor node to reduce the EDCA aggressiveness of the neighbor node may be based on one or more of several conditions. One example of the conditions is that the QoS of the node is above a certain requirement (e.g., a minimum QoS threshold). For example, if the QoS is sufficient (e.g., above the minimum QoS threshold), then the EDCA aggressiveness may be reduced. Another condition is that the MU is above a threshold. Another condition is that traffic is non-real time (e.g., best effort data, a background image, etc.).

There may be several options for determining an amount of the EDCA adjustment for the EDCA parameters. Options for adjusting the EDCA parameters to reduce the EDCA aggressiveness may include at least the following two options. One option is to reduce aggressiveness of a set of the EDCA parameters to next O levels, where O may be a different value for each EDCA parameter. Thus, the EDCA aggressiveness may be gradually (e.g., incrementally) decreased as the EDCA parameters are incrementally adjusted to O levels. The O value may be included in the configuration information. Another option is to reconfigure the EDCA parameters to fixed values with reduced EDCA aggressiveness (e.g., 1-step adjustment). For example, the EDCA aggressiveness may be decreased in a one-step adjustment as the EDCA parameters are decreased to the respective fixed values. If the neighbor node does not receive the EDCA adjustment indicator to reduce the EDCA aggressiveness for certain time duration, the neighbor node may increase the EDCA aggressiveness of the neighbor node. In such a case, the options for increasing EDCA aggressiveness of the neighbor node may include at least the following two options. One option is to increase the EDCA aggressiveness of a set of parameters to next P levels, where P may be a different value for each EDCA parameter. Thus, the EDCA aggressiveness may be gradually increased as the EDCA parameters are incrementally adjusted to respective P levels. The P value for each EDCA parameter may be included in the configuration information. Another option is to immediately restore the EDCA parameters to original values.

The configuration information is explained more in detail below. The configuring device (e.g., the configuring device 802) sends configuration information to each node (e.g., the node 804) to configure the node's decisions/actions for sending an EDCA adjustment indicator (e.g., a 1-bit indicator). The configuring device may be a network server or an access point. The configuration information used for a node to trigger sending a neighbor node an EDCA adjustment indicator to reduce the EDCA aggressiveness of the neighbor node may include a minimum QoS threshold, a minimum MU threshold, and a globally poor threshold. For example, the minimum QoS threshold may be 1 Mbps throughput, and the QoS metric may be at least one of throughput, average packet delay, a packet error rate (PER), and etc. The minimum MU threshold may be, for example, 10% time for transmission. Options for the globally poor threshold are explained infra. The configuration information used for the neighbor node to decide whether to reduce the EDCA aggressiveness of the neighbor node based on the EDCA adjustment indicator may include a high QoS threshold (e.g., 5 Mbps throughput) per application type and the MU threshold (e.g., 40% time for transmission).

The configuration information for the neighbor node to adjust the EDCA parameters to reduce its EDCA aggressiveness may include the EDCA parameters, and a number of levels to be reduced per EDCA parameter. The configuration information for the neighbor node to adjust the EDCA parameters to increase its EDCA aggressiveness (e.g., if the EDCA adjustment indicator to reduce the EDCA aggressiveness is not received for certain time duration) may include the EDCA parameters and a number of levels to be increased per parameter. Thus, the configuration information may include information for determining which parameter to change and how much to change.

Further, the configuration information may include information of timers for a neighbor node for deciding to readjust the EDCA parameters to readjust the EDCA aggressiveness of the neighbor node based on the following options. In one option, the configuration information may include a timer value of Q ms to decide whether to further reduce EDCA aggressiveness of the neighbor node, where Q is a positive number. For example, the neighbor node may decide to reduce the EDCA aggressiveness of the neighbor node when the timer of Q ms expires. In another option, the configuration information may include a timer value of R ms to decide whether to increasing EDCA aggressiveness of the neighbor node, where R is a positive number. For example, the neighbor node may decide to increase the EDCA aggressiveness of the neighbor node when the timer of R ms expires.

As discussed supra, the node may increase its EDCA aggressiveness if the node's QoS is worse than a globally poor performance threshold. The globally poor threshold may be defined based on at least one of the following options. In a first option, the globally poor threshold can be X percentile (percentile) of the QoS or the QoS satisfaction metrics of all streams within the BSS. Thus, if a node is below the X percentile of the QoS or the QoS satisfaction metrics, then the node is eligible for increasing its EDCA aggressiveness. For example, the QoS may be based on at least one of a throughput, an average packet delay, PER, etc. For example, the QoS satisfaction metric for each stream may be a ratio of stream throughput to a minimum standard throughput for the stream.

In a second option, the globally poor threshold may be the worst X percentile among its own BSS and neighbor BSSs. Each BSS has its own percentile number based on the poor node threshold. Among the percentile numbers of the BSSs, the worst X percentile is selected as the threshold. If a node is below the worst X percentile, then the node is eligible for increasing its EDCA aggressiveness. To determine the worst X percentile, if the configuring device is an access point, each access point can broadcast the percentile number of its BSS and determine the worst X percentile by requesting a station served by the access point to report the percentile numbers broadcasted by respective neighbor access points of their respective BSSs. Thus, an access point that is a configuring device may determine the worst X percentile among its own percentile number and percentile numbers of neighbor access points. In another example, the worst X percentile as the globally poor threshold may be determined by selecting S worst percentile numbers and then selecting the largest percentile number among the S worst percentile numbers, where S is a positive number. For example, if S is three, three worst percentile numbers may be obtained, and then the largest number of the three worst percentile numbers may be the worst X percentile. After determining the worst X percentile, the access point may send the worst X percentile to the autonomous node (e.g., node 804) to inform the autonomous node of the worst X percentile.

In a third option, the globally poor threshold can be X percentile of QoS of all streams in a BSS and neighbor BSSs. Thus, according to the third option, a BSS considers the streams from the BSS and neighbor BSSs of the BSS to determine X percentile. To determine X percentile, an access point in a BSS may retrieve QoS of all streams per neighbor BSS, which can be obtained from neighbor access point via OTA relay using a station or via backhaul exchange, and may also retrieve QoS or QoS satisfaction metrics of all streams of its own BSS. For example, if the stations report 50 QoS values for each BSS, and if there are four BSSs, then the BSS considers 200 (50×4) QoS values to determine X percentile.

In the above options, X percentile is based on absolute stream QoS (e.g., throughput, delay, PER, and etc.). In general, different types of traffic streams may have different minimum QoS requirements (e.g. different minimum throughputs). Thus, the node's absolute stream QoS may not reflect whether X percentile based on the absolute stream QoS satisfies a corresponding QoS requirement. That is, the QoS may be normalized based on different minimum QoS requirements to better reflect node's satisfaction with the QoS of the node. Thus, QoS satisfaction metric per stream may be defined as the percentage that the minimum QoS is satisfied. For example, if the QoS is a throughput, the QoS satisfaction metric may be a ratio of actual throughput to the minimum throughput, where the ratio of less than 1 indicates an unsatisfactory result. Then, X percentile is computed based on the ratio. For example, for each cell, if there are 50 throughput numbers and thus corresponding 50 ratios, then nodes that have ratios below the X percentile based on the 50 ratios may be determined. X percentile and the globally poor threshold in the first, second, and third options discussed supra may be computed based on the QoS satisfaction metric instead of absolute QoS. In such a case, a node may increase EDCA aggressiveness of the node if the node's QoS satisfaction metric is worse than the globally poor threshold.

In the second method, a neighbor AP makes the decision for EDCA adjustment. In one configuration of the second method, it is first assumed that each node has single traffic stream. A node represents a transmitter having EDCA parameters. In the second method, a node mainly refers to a station with UL traffic. AP's EDCA adjustment may be similar to that of the autonomous method according to the first method.

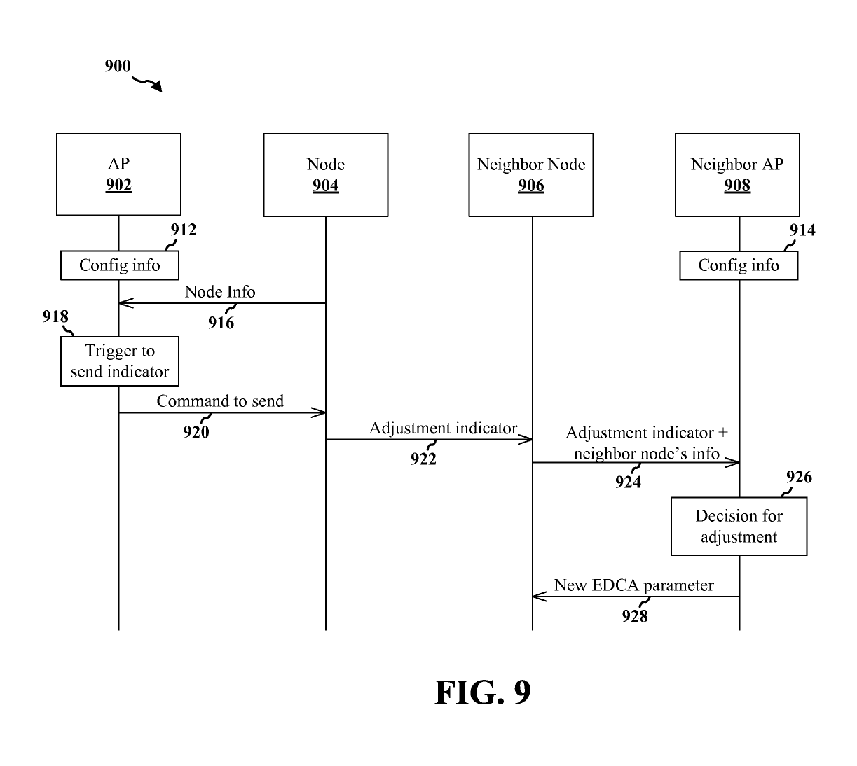

FIG. 9 is an example flow diagram 900 illustrating the second approach's second method. The flow diagram 900 includes an AP 902, a node 904, a neighbor node 906, and a neighbor AP 908. The AP 902 first obtains configuration information for EDCA adjustment decision at 912. The configuration information in the second method may be the same as the configuration information in the autonomous method of the first method described supra. The configuration information is set by a configuring device, which may be the AP 902 itself, a network server, or another AP. Thus, the configuration information may be determined by the AP 902 itself, or may be determined by a network server or another AP and sent to the AP 902. The neighbor AP 908 also obtains the configuration information for EDCA adjustment decision at 914. At 916, the AP 902 receives from a node 904 node information about the node 904. At 918, the AP 902 triggers adjustment of the EDCA parameters, and at 920, the AP 902 sends a command to the node 904, where the command directs the node 904 to send an adjustment indicator to the neighbor node 906. Subsequently, at 922, the node sends the adjustment indicator of the EDCA parameters of the neighbor node 806 to the neighbor node 906. At 924, the neighbor node 906 sends the adjustment indicator and node information of the neighbor node 906 to the neighbor AP 908. At 926, the neighbor AP 908 determines the amount of the EDCA adjustment for the neighbor node 906, based on the configuration information and the node information of the neighbor node 906 from the neighbor node 906. The EDCA adjustment decision in the second method follows similar decision rules and inputs as in the autonomous method of the first method. Finally, at 928, the neighbor AP 908 sends new EDCA parameter(s) representing the decided adjustment to the neighbor node 906.

To determine whether to trigger to increase node's aggressiveness, an AP considers the following node inputs (node information) from the node. The node inputs include the node's MU. The node inputs may include QoS, if the AP does not measure the QoS. The node inputs may include MU per neighbor node, or neighbor nodes' statistics (e.g., an average neighbor MU) if information on the neighbor node's MU is used in an adjustment trigger.

To configure a decision behavior, the AP utilizes configuration information, which may be set by the AP itself, another AP, or a network server. In particular, the configuration information may include a globally poor threshold to evaluate a trigger for increasing the EDCA aggressiveness. In one case, the globally poor threshold is set by the AP itself and may be defined as the worst X percentile of stream QoS or QoS satisfaction metric in a BSS and neighbor BSSs. In such a case, each AP (e.g., the AP and the neighbor APs) can first broadcast X percentile of QoS or QoS satisfaction metrics of all streams in a respective BSS. Subsequently, in such a case, each AP determines the worst X percentile by requesting a respective station to report X percentile broadcasted by neighbor APs. It is noted that, to better reflect node's satisfaction with the QoS, the QoS satisfaction metric (discussed supra) may be used instead of QoS in percentile, where the QoS satisfaction metric may be defined as the percentage that minimum QoS is satisfied.

Several extensions of the EDCA adjustment indicator may exist. According to one extension, the EDCA adjustment indicator can be sent by transmitting node's receiver node to inform neighbor nodes around the receiver node for adjustment, and the EDCA adjustment indicator may also be sent by the transmitter node. The transmitting node can request receiver node of the transmitting node to send the adjustment indicator in receiver node's packets (e.g. CTS/ACK). If both the transmitting node and the receiving node transmit the adjustment indicator, each node may independently send it in a broadcast frame based on a carrier sense multiple access (CSMA). In other words, both sides (both the receiver node and the transmitting node) may send the adjustment indicator, or only a receiver side may send the indicator. In some cases, it may be more desirable to send the adjustment indicator from the receiver node than from the transmitter node because major impact may be from neighbors around the receiver node but not from neighbors around the transmitting node. According to another extension, the adjustment indicator (for aggressiveness) may be intended for a specific group of neighbors. For example, reduction may be only desired for specified group of neighbors, which has large MU, high received signal strength indicator (RSSI), and/or small path loss, as seen from the node (an indicating node) that is sending the adjustment indicator. The indicating node may specify intended neighbor numbers and identifiers (IDs) in the adjustment indicator (e.g., neighbor node's MAC ID, a partial association ID (PAID), and a BSS identifier (BSSID)) to identify the specific group of neighbor nodes.

The adjustment indicator may include finer EDCA tuning suggestion. In particular, multiple bits may be used to specify a reduced level (e.g., an amount of adjustment) and desired EDCA parameters, respectively. Thus, the multiple bits may indicate how much to be reduced for the desired EDCA parameters. The adjustment indicator may include an expiration time for obeying adaptation based on the adjustment indicator. For example, the expiration time may be shorter for less buffered data. The indicator may include an RSSI threshold for obeying adaptation based on the adjustment indicator. For example, adaption may be obeyed if an RSSI of received adjustment indicator is greater than the RSSI threshold (e.g., the neighbor node is close to standard). Further, the adjustment indicator may include detailed metrics to help neighbor make decision. In particular, the metrics may include throughput, packet delay, MU, PER of indicating node. A neighbor node may obey adaptation based on the adjustment indicator if the neighbor node's metric is better than that of the indicating node. The neighbor node will obey the adaptation if it has better performance than the indicating node. The adjustment indicator may include multiple bits to indicate node's traffic type. The traffic type may include voice, video, best effort, background, with decreasing access priority. The neighbor node may decide not to change EDCA if the neighbor node's traffic type has higher priority than indicated traffic type. For example, the neighbor node may ignore the request (and thus decides not to change) if the adjustment indicator has video traffic and the requesting node has only background traffic.

In a case where each node can transmit multiple traffic streams, one implementation is that a single set of EDCA parameters is used for all streams. It is further assumed that the node can optimizes allocation of access opportunities among streams to maximize the worst stream QoS. For example, the node may provide more access opportunities to worse streams. In such a case, the algorithm can be extended by examining the worst stream QoS instead of QoS in action triggers. For example, the adjustment indicator may be sent if node's worst stream QoS is below minimum QoS, and a neighbor node receiving the adjustment indicator may reduce the neighbor node's EDCA aggressiveness if the neighbor node's worst stream QoS is better than a certain requirement.

An incentive policy for obeying the adjustment indicator may be implemented. In a case where obeying the adjustment indicator is optional, the adjustment indicator's support may be facilitated by certain incentive policy. The incentive policy may provide an incentive for more nodes to obey the adjustment indicator. If obeying the adjustment indicator is supported by a device, credits may be awarded to the device or the associated user account. The device may send an indicator of obeying the adjustment indicator to an associated AP or a managing server in a network (e.g., a commercial network). Credits given to the device for obeying the adjustment indicator may include the following three options. In one option, the AP may assign more aggressive EDCA setting for the device. In another option, the AP may assign more time/frequency/space resource for the device. In another option, the device may be given less service charge, especially if the device operates in a commercial network.

There may be several methods to handle legacy nodes. In the presence of incompatible legacy neighbor nodes, it is desirable to minimize impact on compatible neighbor nodes or to make legacy neighbor nodes to obey the adjustment indicator. According to one method, the adjustment indicator is sent only when all neighbors are compatible or most medium is consumed by compatible neighbors. Thus, compatible neighbors will not be penalized if they do not consume most medium. Further, compatible nodes may indicate the support of the adjustment indicator in their packets. Thus, other nodes may know whether the neighbor node is a compatible node. According to another method, inter-AP coordination to make legacy neighbors obey indicator is used. An AP serving the indicating node may relay the indicator to a compatible neighbor AP, which can reconfigure the legacy neighbor node's EDCA parameters accordingly. As discussed supra, the adjustment indicator can specify intended neighbor node IDs. Thus, the neighbor AP can change EDCA parameters or intended neighbor node IDs. It is noted that the inter-AP communications may be made via OTA messages or backhaul.

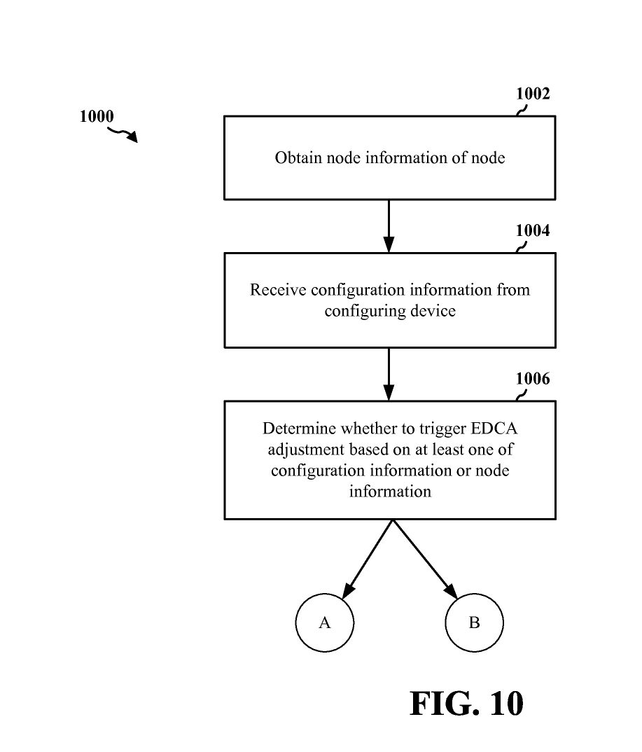

FIG. 10 is a flow chart 1000 of a method of wireless communication. The method 1000 may be performed using an apparatus (e.g., the wireless device 202 of FIG. 2, for example). The apparatus may be implemented as a node, for example. Although the process 1000 is described below with respect to the elements of wireless device 202 of FIG. 2, other components may be used to implement one or more of the steps described herein.

At 1002, the node obtains node information of the node. At 1004, the node receives configuration information from a configuring device. At 1006, the node determines whether to trigger an EDCA adjustment based on at least one of the configuration information or the node information. Subsequently, the node may proceed with option A or option B. Obtaining the node information may be performed by the processor 204. Receiving the configuration information may be performed by the processor 204 and/or the receiver 212, for example. Determining whether to trigger the EDCA adjustment may be performed by the processor 204.

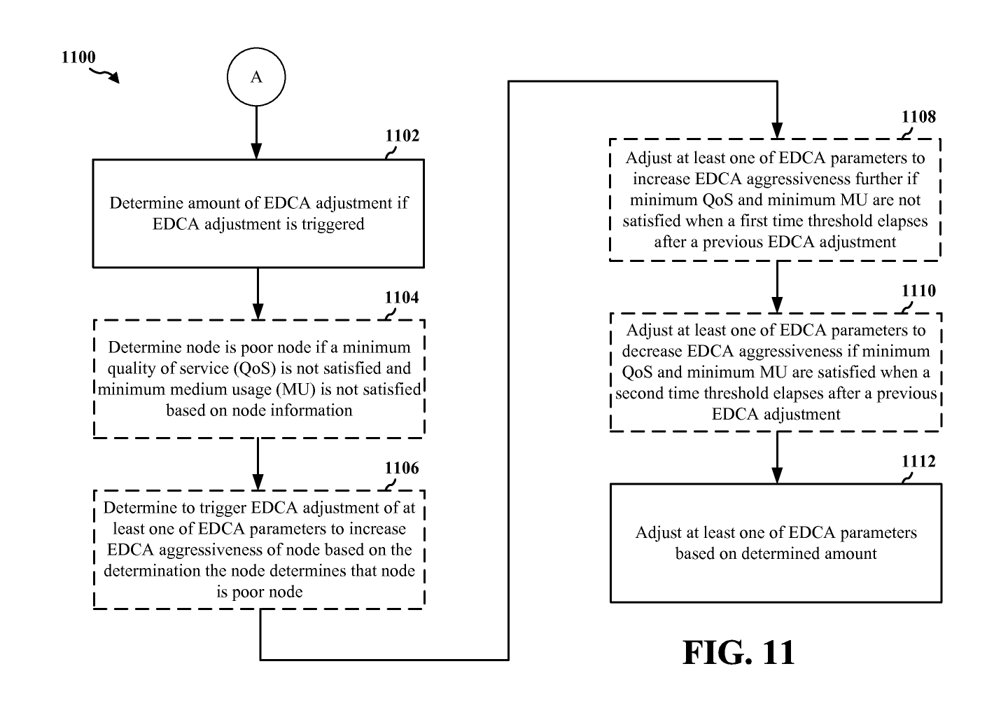

FIG. 11 is a flow chart 1100 of a method of wireless communication expanding from the flow chart 1000 of FIG. 10, where the node proceeds with option A from FIG. 10. At 1102, the node determines an amount of the EDCA adjustment if the EDCA adjustment is triggered. Determining the amount of the EDCA adjustment if the node determines to trigger the EDCA adjustment may be performed by the processor 204. At 1104, the node may determine that the node is a poor node if a minimum QoS is not satisfied and a minimum MU is not satisfied based on the node information. Determining that the node is a poor node if a minimum QoS is not satisfied and a minimum MU is not satisfied may be performed by the processor 204. At 1106, the node may determine to trigger the EDCA adjustment of at least one of the EDCA parameters to increase the EDCA aggressiveness of the node based on the determination that the node is the poor node. Determining to trigger the EDCA adjustment of at least one of the EDCA parameters to increase the EDCA aggressiveness of the node if the node is identified as the poor node may be performed by the processor 204. At 1108, the node may adjust at least one of the EDCA parameters to increase the EDCA aggressiveness further if the minimum QoS and the minimum MU are not satisfied when a first time threshold elapses after a previous EDCA adjustment. Adjusting at least one of the EDCA parameters to increase the EDCA aggressiveness further if the minimum QoS and the minimum MU are not satisfied when a first time threshold elapses after a previous EDCA adjustment may be performed by the processor 204. At 1110, the node may adjust at least one of the EDCA parameters to decrease the EDCA aggressiveness if the minimum QoS and the minimum MU are satisfied when a second time threshold elapses after a previous EDCA adjustment. Adjusting at least one of the EDCA parameters to decrease the EDCA aggressiveness if the minimum QoS and the minimum MU are satisfied when a second time threshold elapses after a previous EDCA adjustment may be performed by the processor 204. In an aspect, the first time threshold and the second time threshold are included in the configuration information. At 1112, the node adjusts at least one of EDCA parameters based on the determined amount of the EDCA adjustment. Adjusting at least one of EDCA parameters based on the determined amount of the EDCA adjustment may be performed by the processor 204.

Referring back to FIG. 4, for example, at 412, the configuring device 402 sends the configuration information to the node 404, in order to configure a decision behavior of the node 404, and subsequently, at 414, the node 404 makes an EDCA adjustment decision based on the configuration information. Referring back to FIG. 4, for example, at 416, after receiving the configuration information, the node 404 autonomously triggers adjustment of its own EDCA parameters, and at 418, the node 404 determines the amount of the adjustment, based on the configuration information.

As discussed supra, for example, a node identifies itself as a poor node if a minimum QoS of the node is not satisfied and a minimum medium usage is not satisfied. As discussed supra, for example, if the node identifies itself as a poor node, the poor node will then adjust the EDCA parameters to increase its EDCA aggressiveness. As discussed supra, for example, if the minimum QoS and the minimum MU are still not satisfied after certain time duration (e.g., M ms), the node may adjust the EDCA parameters to further increase the EDCA aggressiveness. As discussed supra, for example, if the minimum QoS and the minimum MU are satisfied for a certain time duration (e.g., for N ms) since a previous adjustment of the EDCA parameter(s), the node may adjust the EDCA parameters to decrease the EDCA aggressiveness to a next level.

In an aspect, adjusting at least one of the EDCA parameters to increase the EDCA aggressiveness may be performed by at least one of decreasing a minimum contention window, decreasing a maximum contention window, increasing a transmit opportunity duration, or increasing an arbitration inter-frame space number. In an aspect, the EDCA adjustment trigger to increase the EDCA aggressiveness is based on at least one of multiple conditions, where the first condition is that QoS of the node does not satisfy the minimum QoS, the second condition is that an MU of the node is below the minimum MU threshold, the third condition is that the QoS or a QoS satisfaction metric of the node is worse than a globally-poor threshold, the third condition is that the QoS or the QoS satisfaction metric of the node is worse than a globally-poor threshold, the fourth condition is that a node stream is real time, the fifth condition is that a ratio of the MU of the node to an average neighbor node MU is below a threshold, the sixth condition is that an RTS/CTS is enabled, and the seventh condition is that a rate supported by a link quality is above a minimum rate threshold. In an aspect, according to the fifth condition, the node may determine the average neighbor node MU based on an individual neighbor node MU indicated in neighbor node's packets.

In an aspect, the configuration information may include first information considered in determining to trigger the EDCA adjustment to increase the EDCA aggressiveness, the first information including at least one of a minimum QoS threshold, a minimum MU threshold, or a globally-poor threshold. In an aspect, the configuration information may include second information considered in determining to trigger the EDCA adjustment to decrease an EDCA aggressiveness, the second information including a high QoS threshold, and the node may adjust the at least one of the EDCA parameters to decrease the EDCA aggressiveness if QoS of the node is above the high QoS threshold. In an aspect, the configuration information may include EDCA parameters and the amount of EDCA adjustment for each of the parameters. In such an aspect, the amount of EDCA adjustment may be based on a number of level increments for respective EDCA parameters or is based on fixed values for respective EDCA parameters.

In an aspect, the globally-poor threshold may be a percentile number for QoS satisfaction metrics of all streams within a BSS to which the node belongs, and each QoS satisfaction metric of each stream may be based at least on a ratio of stream throughput to a respective minimum standard throughput. In an aspect, the globally-poor threshold may be a largest number of R smallest percentile numbers among a percentile number of QoS satisfaction metric of streams in a BSS to which the node belongs and percentile numbers of QoS satisfaction metric of streams in respective neighbor BSSs, R being a positive number. In an aspect, if the configuring device is an access point, each of the access point in the BSS to which the node belongs and neighbor access points in respective neighbor BSSs may broadcast a respective percentile number for the QoS satisfaction metrics of streams in a corresponding BSS, and the access point may determine the globally-poor threshold based on a percentile number for the access point and percentile numbers for neighbor access points by requesting the node served by the access point to report percentile numbers broadcasted by respective neighbor access points and may send the globally-poor threshold to the node to be configured. In an aspect, the globally-poor threshold may be a percentile number of QoS satisfaction metrics of all streams of a BSS to which the node belongs and neighbor BSSs. In such an aspect, each of an access point in the BSS to which the node belongs and neighbor access points in respective neighbor BSSs may broadcast the QoS satisfaction metrics of streams in a corresponding BSS, and the access point for the BSS may obtain the QoS satisfaction metrics of all streams of the BSS and the neighbor BSSs, and may determine the percentile number for the QoS satisfaction metrics of all streams by requesting the node served by the access point to report the QoS satisfaction metrics of streams broadcasted by respective neighbor access points.

In an aspect, the configuration information may be sent to the node from the configuring device in OTA frames if the configuring device is an access point and the node is a station. In such an aspect, the OTA frames may include at least one of beacon frames, probe/association response frames, or unicast/multicast management frames.

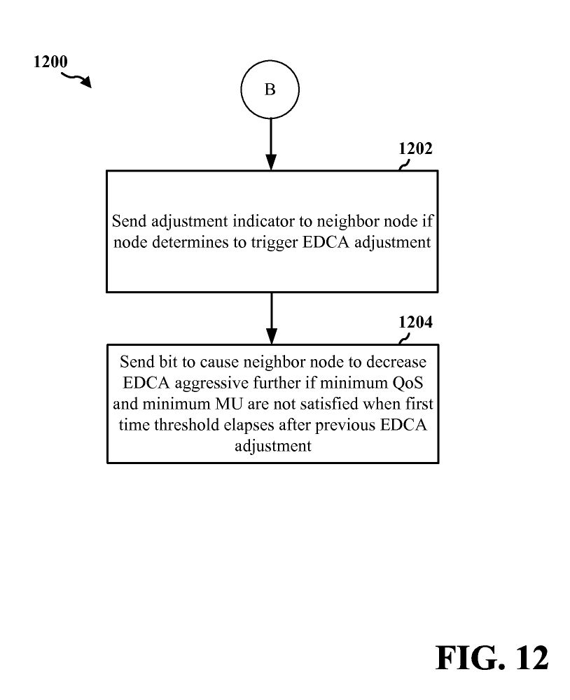

FIG. 12 is a flow chart 1200 of a method of wireless communication expanding from the flow chart 1000 of FIG. 10, where the node proceeds with option B from FIG. 10. At 1202, the node sends an adjustment indicator to a neighbor node if the node determines to trigger the EDCA adjustment. In an aspect, the neighbor node determines an amount of the EDCA adjustment after receiving the adjustment indicator and adjusts at least one of EDCA parameters based on the determined amount. In an aspect, the neighbor node receives the configuration information from the configuring device. Sending an adjustment indicator to a neighbor node if the node determines to trigger the EDCA adjustment may be performed by the processor 204 and/or the transmitter 210. At 1204, the node may send a bit to cause the neighbor node to decrease an EDCA aggressiveness further if a minimum QoS and a minimum MU are not satisfied when a first time threshold elapses after a previous EDCA adjustment. In an aspect, the neighbor node adjusts at least one of EDCA parameters to increase the EDCA aggressiveness if the neighbor node does not hear the bit after a second time threshold. In such an aspect, adjusting the at least one of the EDCA parameters to decrease the EDCA aggressiveness may be performed by at least one of increasing a minimum contention window, increasing a maximum contention window, decreasing a transmit opportunity duration, or decreasing an arbitration inter-frame space number. Sending a bit to cause the neighbor node to decrease the EDCA aggressiveness further if the minimum QoS and the minimum MU are not satisfied when a first time threshold elapses after a previous EDCA adjustment may be performed by the processor 204 and/or the transmitter 210.

Referring back to FIG. 8, for example, the configuring device 802 sends at 812 configuration information from a network to the node 804, and also sends at 814 the configuration information to the neighbor node 806, in order to configure decision behaviors of the node 804 and the neighbor node 806, respectively. Referring back to FIG. 8, for example, at 816, after receiving the configuration information, the node 804 triggers to send an EDCA adjustment indicator of the EDCA parameters of the neighbor node 806. Referring back to FIG. 8, for example, upon the trigger to send the EDCA adjustment indicator, at 818, the node 804 autonomously sends the EDCA adjustment indicator 818 to the neighbor node 806, and at 820, the neighbor node 806 determines the amount of the adjustment, based on the configuration information.

As discussed supra, for example, if a minimum QoS of the node is not satisfied and a minimum medium usage is not satisfied, a node identifies itself as a poor node and sends its neighbor node an EDCA adjustment indicator (e.g., in packets) to reduce EDCA aggressiveness of the neighbor node. As discussed supra, for example, if the neighbor node continues to receive the EDCA adjustment indicator to reduce the EDCA aggressiveness after certain time duration (e.g., M ms), the neighbor node may adjust the EDCA parameters to further reduce the EDCA aggressiveness of the neighbor node. As discussed supra, for example, if the neighbor node stops receiving the EDCA adjustment indicator to reduce the EDCA aggressiveness after certain time duration (e.g., for N ms) since a previous adjustment of the EDCA parameter(s), the neighbor node may adjust the EDCA parameters to gradually or immediately increase the EDCA aggressiveness to the original setting.

In an aspect, the EDCA adjustment trigger for a bit to cause the neighbor node to decrease the EDCA aggressiveness may be based on at least one of multiple conditions, where the first condition is that the QoS does not satisfy the minimum QoS, the second condition is that the MU is below a minimum MU threshold, the third condition is that the QoS or QoS satisfaction metric is worse than a globally-poor threshold, the fourth condition is that a node stream is a real time, the fifth condition is that a ratio of the node's MU to an average neighbor MU is below a threshold, the sixth condition is that RTS/CTS is already enabled, and the seventh condition is that a rate supported by a link quality is above a threshold. In such an aspect, according to the fifth condition, the node may indicate MU in node's packets. In an aspect, a trigger to decrease the EDCA aggressiveness may be based on at least one of multiple conditions, where the first condition is that a QoS is above a QoS threshold, the second condition is that MU is above an MU threshold, and the third condition is that the stream is non-real time.

In an aspect, the configuration information sent to the node may include first information considered in setting the bit to trigger decreasing the EDCA aggressiveness of the neighbor node, the first information including at least one of a minimum QoS threshold, a minimum MU threshold, or a globally-poor threshold. In an aspect, the configuration information sent to the neighbor node may include second information considered in determining to trigger decreasing the EDCA aggressiveness after receiving the bit, the second information including a QoS threshold per application type and an MU threshold. In an aspect, the configuration information sent to the neighbor node may include EDCA parameters and an amount of EDCA adjustment for each of the parameters for increasing or decreasing an EDCA aggressiveness of the neighbor node. In an aspect, a globally-poor threshold may be a percentile number for QoS satisfaction metrics of all streams within a BSS to which the node belongs, and each QoS satisfaction metric of each stream may be based at least on a ratio of a stream throughput to a respective minimum standard throughput.

In an aspect, the globally-poor threshold may be a largest number of R smallest percentile numbers among a percentile number of QoS satisfaction metrics of streams in a BSS to which the node belongs and percentile numbers of QoS satisfaction metrics of streams in respective neighbor BSSs, R being a positive number. In such an aspect, if the configuring device is an access point, each of the access point in the BSS to which the node belongs and neighbor access points in respective neighbor BSSs may broadcast a respective percentile number for the QoS satisfaction metrics of streams in a corresponding BSS, and the access point may determine the globally-poor threshold based on a percentile number for the access point and percentile numbers for neighbor access points by requesting the node served by the access point to report percentile numbers broadcasted by respective neighbor access points and may send the globally-poor threshold to the node to be configured.

In an aspect, the globally-poor threshold may be a percentile number of QoS satisfaction metric of all streams of a BSS to which the node belongs and neighbor BSSs. In such an aspect, each of an access point in the BSS to which the node belongs and neighbor access points in respective neighbor BSSs may broadcast a respective percentile number for QoS satisfaction metrics of streams in a corresponding BSS, and the access point for the BSS may obtain the QoS satisfaction metrics of all streams of the BSS and the neighbor BSSs, and may determine the percentile number for the QoS satisfaction metrics of all streams by requesting the node served by the access point to report the QoS satisfaction metrics of streams broadcasted by respective neighbor access points.

In an aspect, a receiver of data transmission of the node may send an indicator to the neighbor nodes around the receiver for EDCA adjustment, and the node may request the receiver to send the indicator in the receiver's packets. In an aspect, the adjustment indicator may be directed to a group of neighbor nodes to perform EDCA adjustment on the group of neighbor nodes, the group of neighbor nodes being specified based on at least one of an MU, RSSI, or path loss. In such an aspect, the node may specify numbers and identifiers of the neighbor nodes in the group of neighbor nodes to identify the group of neighbor nodes.

In an aspect, the adjustment indicator may include at least one of a plurality of bits used to specify an amount of EDCA adjustment and at least one of EDCA parameters to be adjusted, an expiration time to perform EDCA adjustment, or an RSSI threshold for performing EDCA adjustment. In such an aspect, the adjustment indicator may include metrics to compare with metrics of the neighbor nodes, where the neighbor nodes may perform the EDCA adjustment if the neighbor nodes have better metrics than the indicating node, the metrics including at least one of throughput, a packet delay, MU, or a PER of the node.

In an aspect, the adjustment indicator may include a plurality of bits to indicate a traffic type of the node, the traffic type including at least one of voice, video, best effort, or background, in an order of decreasing access priority, and the neighbor node may decide not to perform EDCA adjustment if the neighbor node's traffic type has a higher priority than the traffic type of the node indicated in the adjustment indicator.

In an aspect, the configuring device may be an access point, and the access point may send an indicator to indicate that the access point supports EDCA adjustment per individual station. In an aspect, the node may send an indicator to indicate that the node supports autonomous EDCA adjustment by the node.

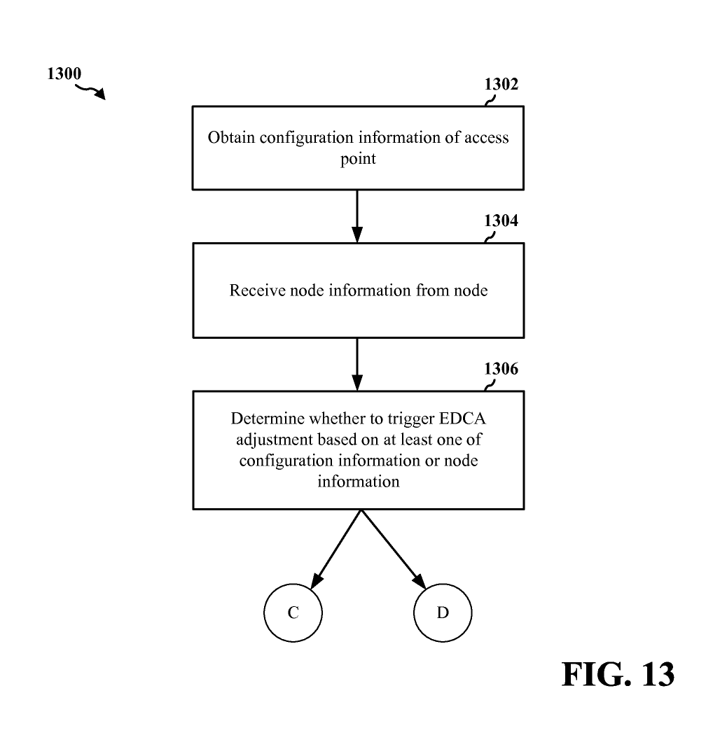

FIG. 13 is a flow chart 1300 of a method of wireless communication. The method 1300 may be performed using an apparatus (e.g., the wireless device 202 of FIG. 2, for example). The apparatus may be implemented as an AP, for example. Although the process 1300 is described below with respect to the elements of wireless device 202 of FIG. 2, other components may be used to implement one or more of the steps described herein.

At 1302, the access point obtains configuration information of the access point. At 1304, the access point receives node information from a node. At 1306, the access point determines whether to trigger an EDCA adjustment based on at least one of the configuration information or the node information. Obtaining configuration information of the access point may be performed by the processor 204. Receiving the node information from the node may be performed by the processor 204 and/or the receiver 212. Determining whether to trigger an EDCA adjustment based on at least one of the configuration information or the node information may be performed by the processor 204. After 1306, the access point may proceed with option C or option D.

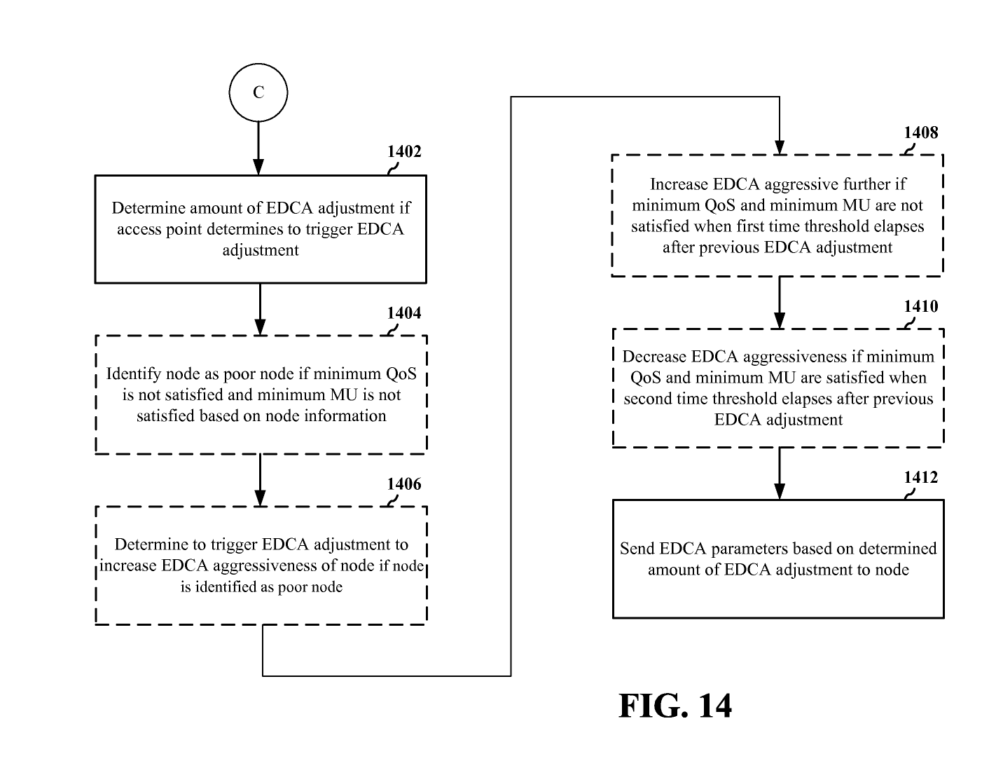

FIG. 14 is a flow chart 1400 of a method of wireless communication expanding from the flow chart 1300 of FIG. 13, where the node proceeds with option C from FIG. 13. At 1402, the access point determines an amount of the EDCA adjustment if the access point determines to trigger the EDCA adjustment. Determining the amount of the EDCA adjustment if the access point determines to trigger the EDCA adjustment may be performed by the processor 204. At 1404, the access point may identify the node as a poor node if a minimum QoS is not satisfied and minimum MU is not satisfied based on the node information. Identifying the node as a poor node if a minimum QoS is not satisfied and minimum MU is not satisfied based on the node information may be performed by the processor 204. At 1406, the access point may determine to trigger the EDCA adjustment to increase an EDCA aggressiveness of the node if the node is identified as the poor node. Determining to trigger the EDCA adjustment to increase EDCA aggressiveness of the node may be performed by the processor 204. At 1408, the access point may increase an EDCA aggressiveness further if a minimum QoS and the minimum MU are not satisfied when a first time threshold elapses after a previous EDCA adjustment. Increasing the EDCA aggressiveness further if the minimum QoS and the minimum MU are not satisfied when a first time threshold elapses after a previous EDCA adjustment may be performed by the processor 204. At 1410, the access point may decrease the EDCA aggressiveness if the minimum QoS and the minimum MU are not satisfied when a second time threshold elapses after a previous EDCA adjustment. Decreasing the EDCA aggressiveness if the minimum QoS and the minimum MU are not satisfied when a second time threshold elapses after a previous EDCA adjustment may be performed by the processor 204. At 1412, the access point sends EDCA parameters based on the determined amount of the EDCA adjustment to the node. Sending the EDCA parameters based on the determined amount of the EDCA adjustment to the node may be performed by the processor 204 and/or the transmitter 210.

Referring back to FIG. 5, for example, the AP 502 first obtains configuration information for EDCA adjustment decision at 512, and may receive from a node 504 node information about the node 504 at 514. Subsequently, at 516, the AP 502 makes an EDCA adjustment decision based on the configuration information. Referring back to FIG. 5, for example, at 518, the AP 502 triggers adjustment of the EDCA parameters, and at 522, the AP 502 determines an amount of the EDCA adjustment, based on the configuration information and the node information from the node 504. Referring back to FIG. 5, for example, at 524, the AP 502 sends the EDCA parameters representing the decided EDCA adjustment to the node 504.

As discussed supra, for example, an AP identifies that a node is poor based on information from the node, and subsequently increases the poor node's EDCA aggressiveness. A node is poor if the node's minimum QoS and minimum MU requirements are not satisfied. As discussed supra, for example, during the EDCA adjustment decision 516, if the AP 502 detects that the node 504 is still poor after a certain time duration (e.g., M ms), the AP 502 determines to further increase the EDCA aggressiveness. As discussed supra, for example, during the EDCA adjustment decision 516, if the AP 502 detects that the minimum QoS and the minimum MU requirements are satisfied after certain time duration (e.g., N ms), the AP 502 determines to decrease the node's EDCA aggressiveness.

In an aspect, the node information received from the node may include at least one of an MU of the node, QoS of the node, or MU information of neighbor nodes. In such an aspect, the node information may include the QoS of the node if the access point does not measure the QoS, and the node information may include the MU information of the neighbor nodes if the MU information of the neighbor nodes is used in determining whether to trigger the EDCA adjustment, the MU information of the neighbor nodes including at least one of an MU per neighbor node or MU statistics of the neighbor nodes.

In an aspect, the configuration information may include a globally-poor threshold to be used in determining whether to trigger the EDCA adjustment. In such an aspect, the globally-poor threshold may be set by the access point and may be a largest number of R smallest percentile numbers among a percentile number of QoS satisfaction metrics of streams in a BSS to which the node belongs and percentile numbers of QoS satisfaction metrics of streams in respective neighbor BSSs, R being a positive number, and each access point broadcasts a percentile number for QoS satisfaction metric of all streams in a corresponding BSS, and may subsequently determine the globally-poor threshold by requesting a station served by the access point to report percentile numbers broadcasted by respective neighbor access points.

In an aspect, the access point may send a request to the node to report the node information if the access point determines a potential need for increasing an EDCA aggressiveness of the node. In such an aspect, the access point may send the request to the node periodically or whenever the access point detects that the node's QoS does not satisfy a minimum QoS requirement.

In an aspect, the access point may send a configuration message to the node with conditions that are considered in determining whether to send an adjustment request, and if the conditions in the configuration message are satisfied, the node may send an EDCA adjustment request to the access point. In such an aspect, the EDCA adjustment request may include at least one of an indicator for increasing or decreasing EDCA aggressiveness or preferred new EDCA parameters.

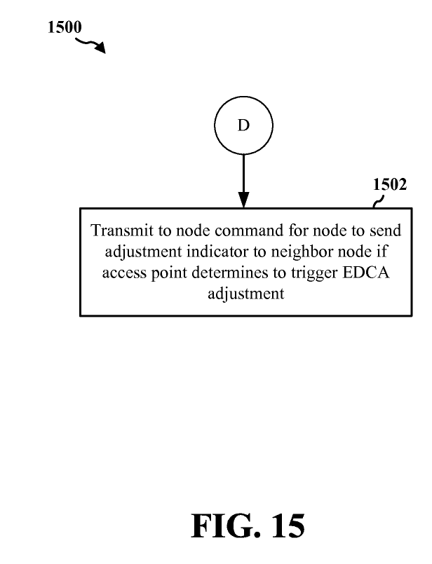

FIG. 15 is a flow chart 1500 of a method of wireless communication expanding from the flow chart 1300 of FIG. 13, where the node proceeds with option D from FIG. 13. At 1502, the access point transmits to the node a command for the node to send an adjustment indicator to a neighbor node if the access point determines to trigger the EDCA adjustment. In an aspect, the neighbor node sends the received adjustment indicator and neighbor node information to a neighbor access point serving the neighbor node, and the neighbor node subsequently determines an amount of the EDCA adjustment if the access point determines to trigger the EDCA adjustment and sends EDCA parameters based on the determined amount of the EDCA adjustment to the neighbor node. Transmitting to the node the command for the node to send the adjustment indicator to the neighbor node if the access point determines to trigger the EDCA adjustment may be performed by the processor 204 and/or the transmitter 210.

Referring back to FIG. 9, for example, the AP 902 first obtains configuration information for EDCA adjustment decision at 912, and the neighbor AP 908 also obtains the configuration information for EDCA adjustment decision at 914. Referring back to FIG. 9, for example, at 916, the AP 902 receives from a node 904 node information about the node 904. Referring back to FIG. 9, for example, at 918, the AP 902 triggers adjustment of the EDCA parameters, and at 920, the AP 902 sends a command to the node 904, where the command directs the node 904 to send an adjustment indicator to the neighbor node 906. Subsequently, at 922, the node sends the adjustment indicator of the EDCA parameters of the neighbor node 806 to the neighbor node 906. Referring back to FIG. 9, for example, at 924, the neighbor node 906 sends the adjustment indicator and node information of the neighbor node 906 to the neighbor AP 908. Referring back to FIG. 9, for example, at 926, the neighbor AP 908 determines the amount of the EDCA adjustment for the neighbor node 906, based on the configuration information and the node information of the neighbor node 906 from the neighbor node 906. Referring back to FIG. 9, for example, at 928, the neighbor AP 908 sends new EDCA parameter(s) representing the decided adjustment to the neighbor node 906.

In an aspect, the node information received from the node may include at least one of a MU of the node, QoS of the node, or MU information of neighbor nodes. In such an aspect, the node information may include the QoS of the node if the access point does not measure QoS and may include the MU information of the neighbor nodes if the MU information of the neighbor nodes is used in determining whether to trigger the EDCA adjustment, the MU information of the neighbor nodes including at least one of an MU per neighbor node or MU statistics of the neighbor nodes.

In an aspect, the configuration information may include a globally-poor threshold to be used in determining whether to trigger the EDCA adjustment. In such an aspect, the configuring device may be an access point and the globally-poor threshold may be a largest number of R smallest percentile numbers of QoS satisfaction metrics of all streams in a BSS to which the node belongs and neighbor BSSs, R being a positive number, and each access point may broadcast a percentile number for QoS satisfaction metrics of all streams in a corresponding BSS, and may subsequently determine the globally-poor threshold by requesting a station served by the access point to report percentile numbers broadcasted by respective neighbor access points.

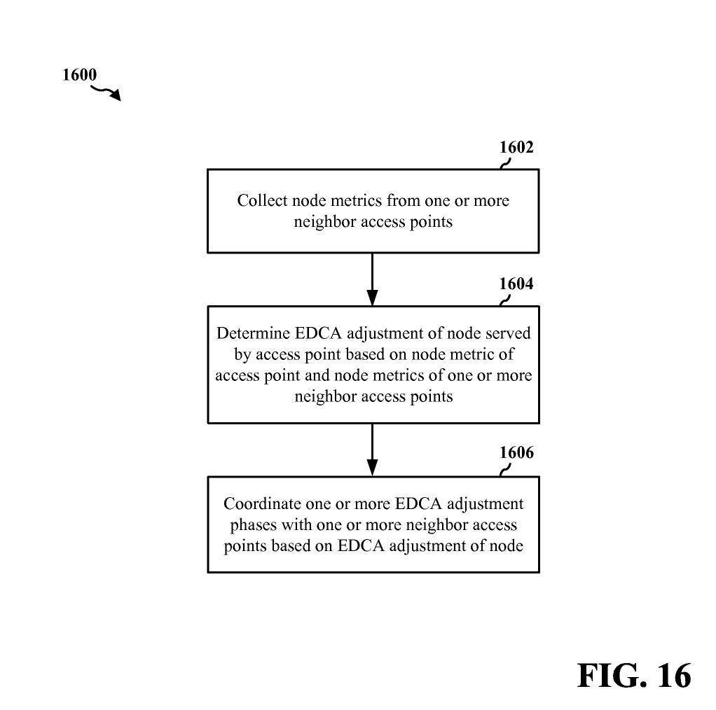

FIG. 16 is a flow chart 1600 of a method of wireless communication. The method 1600 may be performed using an apparatus (e.g., the wireless device 202 of FIG. 2, for example). The apparatus may be implemented as an AP, for example. Although the process 1600 is described below with respect to the elements of wireless device 202 of FIG. 2, other components may be used to implement one or more of the steps described herein.

At 1602, the access point collects node metrics from one or more neighbor access points. At 1604, the access point determines an EDCA adjustment of a node served by the access point based on a node metric of the access point and the node metrics of the one or more neighbor access points. At 1606, the access point coordinates one or more EDCA adjustment phases with the one or more neighbor access points based on the EDCA adjustment of the node. Collecting node metrics from one or more neighbor access points may be performed by the processor 204 and/or the receiver 212. Determining an EDCA adjustment of a node served by the access point based on a node metric of the access point and the node metrics of the one or more neighbor access points may be performed by the processor 204. Coordinating one or more EDCA adjustment phases with the one or more neighbor access points based on the EDCA adjustment of the node may be performed by the processor 204 and/or the transmitter 210.

Referring back to FIG. 7, for example, during the first period 712, the AP gathers node metrics per BSS in the network. Referring back to FIG. 7, for example, during the second period 714, the AP decides whether to make the EDCA adjustment, and an amount of the EDCA adjustment. Referring back to FIG. 7, for example, during the third period 716, nodes use adjusted EDCA for transmission.

In an aspect, the access point and the one or more neighbor access points may exchange coordination messages to coordinate the one or more EDCA adjustment phases. In an aspect, each of the one or more EDCA adjustment phases may include a first period to collect the node metrics from one or more neighbor access points, a second period to determine whether to make the EDCA adjustment, and an amount of the EDCA adjustment, and a third period where a node uses an adjusted EDCA for transmission. In an aspect, the access point may increase EDCA aggressiveness for nodes in a percentile number if the percentile number is below a first threshold, and the access point may decrease the EDCA aggressiveness for nodes in the percentile number if the percentile number is greater a second threshold, the second threshold being greater than the first threshold.

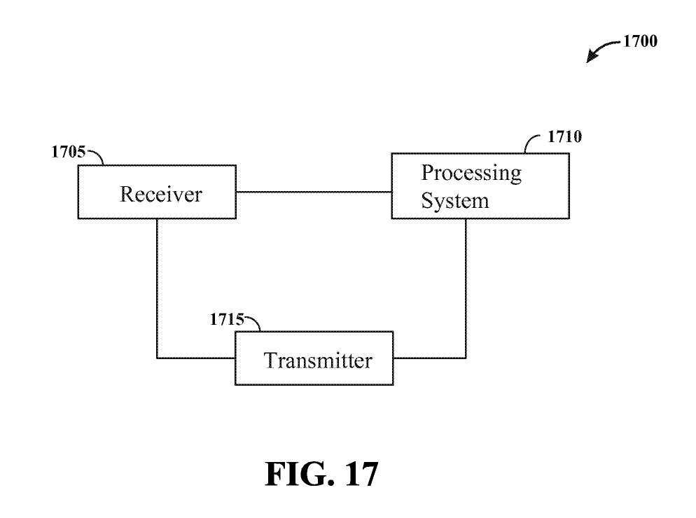

FIG. 17 is a functional block diagram of an example wireless communication device 1700. The wireless communication device 1700 may include a receiver 1705, a processing system 1710, and a transmitter 1715.

According to one example, the wireless communication device 1700 may be a node. In such an example, the processing system 1710 may be configured to obtain node information of the node. The processing system 1710 and/or the receiver 1705 may be configured to receive configuration information from a configuring device. The processing system 1710 may be configured to determine whether to trigger an EDCA adjustment based on at least one of the configuration information or the node information.

The processing system 1710 may be configured to determine an amount of the EDCA adjustment if the node determines to trigger the EDCA adjustment. The processing system 1710 may be configured to identify the node as a poor node if a minimum QoS is not satisfied and a minimum MU is not satisfied based on the node information. The processing system 1710 may be configured to determine to trigger the EDCA adjustment of the EDCA parameters to increase the EDCA aggressiveness of the node if the node is identified as the poor node. The processing system 1710 may be configured to adjust the EDCA parameters to increase the EDCA aggressiveness further if the minimum QoS and the minimum MU are not satisfied when a first time threshold elapses after a previous EDCA adjustment. The processing system 1710 may be configured to adjust the EDCA parameters to decrease the EDCA aggressiveness if the minimum QoS and the minimum MU are satisfied when a second time threshold elapses after a previous EDCA adjustment. The processing system 1710 may be configured to adjust EDCA parameters based on the determined amount of the EDCA adjustment.

In an aspect, adjusting the EDCA parameters to increase the EDCA aggressiveness may be performed by at least one of decreasing a minimum contention window, decreasing a maximum contention window, increasing a transmit opportunity duration, or increasing an arbitration inter-frame space number. In an aspect, the EDCA adjustment trigger to increase the EDCA aggressiveness is based on at least one of a first through seventh conditions, where the first condition is that QoS of the node does not satisfy the minimum QoS, the second condition is that the MU of the node is below the minimum MU threshold, the third condition is that the QoS or QoS satisfaction metric of the node is worse than a globally-poor threshold, the third condition is that the QoS or QoS satisfaction metric of the node is worse than a globally-poor threshold, the fourth condition is that node's stream is real time, the fifth condition is that a ratio of the MU of the node to an average neighbor node MU is below a threshold, the sixth condition is that an RTS/CTS is enabled, and the seventh condition is that a rate supported by link quality is above a minimum rate threshold. In an aspect, according to the fifth condition, the node may determine the average neighbor node MU based on individual neighbor node MU indicated in neighbor node's packets.

In an aspect, adjusting the EDCA parameters to increase the EDCA aggressiveness may be performed by at least one of decreasing a minimum contention window, decreasing a maximum contention window, increasing a transmit opportunity duration, or increasing an arbitration inter-frame space number. In an aspect, the EDCA adjustment trigger to increase the EDCA aggressiveness is based on at least one of multiple conditions, where the first condition is that QoS of the node does not satisfy the minimum QoS, the second condition is that an MU of the node is below the minimum MU threshold, the third condition is that the QoS or a QoS satisfaction metric of the node is worse than a globally-poor threshold, the third condition is that the QoS or the QoS satisfaction metric of the node is worse than a globally-poor threshold, the fourth condition is that a node stream is real time, the fifth condition is that a ratio of the MU of the node to an average neighbor node MU is below a threshold, the sixth condition is that an RTS/CTS is enabled, and the seventh condition is that a rate supported by a link quality is above a minimum rate threshold. In an aspect, according to the fifth condition, the node may determine the average neighbor node MU based on an individual neighbor node MU indicated in neighbor node's packets.

In an aspect, the configuration information may include first information considered in determining to trigger the EDCA adjustment to increase the EDCA aggressiveness, the first information including at least one of a minimum QoS threshold, a minimum MU threshold, or a globally-poor threshold. In an aspect, the configuration information may include second information considered in determining to trigger the EDCA adjustment to decrease an EDCA aggressiveness, the second information including a high QoS threshold, and the node may adjust the EDCA parameters to decrease the EDCA aggressiveness if QoS of the node is above the high QoS threshold. In an aspect, the configuration information may include EDCA parameters and the amount of EDCA adjustment for each of the parameters. In such an aspect, the amount of EDCA adjustment may be based on a number of level increments for respective EDCA parameters or is based on fixed values for respective EDCA parameters.

In an aspect, the globally-poor threshold may be a percentile number for QoS satisfaction metrics of all streams within a BSS to which the node belongs, and each QoS satisfaction metric of each stream may be based at least on a ratio of stream throughput to a respective minimum standard throughput. In an aspect, the globally-poor threshold may be a largest number of R smallest percentile numbers among a percentile number of QoS satisfaction metric of streams in a BSS to which the node belongs and percentile numbers of QoS satisfaction metric of streams in respective neighbor BSSs, R being a positive number. In an aspect, if the configuring device is an access point, each of the access point in the BSS to which the node belongs and neighbor access points in respective neighbor BSSs may broadcast a respective percentile number for the QoS satisfaction metrics of streams in a corresponding BSS, and the access point may determine the globally-poor threshold based on a percentile number for the access point and percentile numbers for neighbor access points by requesting the node served by the access point to report percentile numbers broadcasted by respective neighbor access points and may send the globally-poor threshold to the node to be configured. In an aspect, the globally-poor threshold may be a percentile number of QoS satisfaction metrics of all streams of a BSS to which the node belongs and neighbor BSSs. In such an aspect, each of an access point in the BSS to which the node belongs and neighbor access points in respective neighbor BSSs may broadcast the QoS satisfaction metrics of streams in a corresponding BSS, and the access point for the BSS may obtain the QoS satisfaction metrics of all streams of the BSS and the neighbor BSSs, and may determine the percentile number for the QoS satisfaction metrics of all streams by requesting the node served by the access point to report the QoS satisfaction metrics of streams broadcasted by respective neighbor access points.

In an aspect, the configuration information may be sent to the node from the configuring device in OTA frames if the configuring device is an access point and the node is a station. In such an aspect, the OTA frames may include at least one of beacon frames, probe/association response frames, or unicast/multicast management frames.

The processing system 1710 and/or the transmitter 1715 may be configured to send an adjustment indicator to a neighbor node if the node determines to trigger the EDCA adjustment. In an aspect, the neighbor node determines an amount of the EDCA adjustment after receiving the adjustment indicator and adjusts the EDCA parameters based on the determined amount. In an aspect, the neighbor node receives the configuration information from the configuring device. The processing system 1710 and/or the transmitter 1715 may be configured to send a bit to cause the neighbor node to decrease the EDCA aggressiveness further if a minimum QoS and a minimum MU are not satisfied when a first time threshold elapses after a previous EDCA adjustment. In an aspect, the neighbor node adjusts EDCA parameters to increase the EDCA aggressiveness if the neighbor node does not hear the bit after a second time threshold. In such an aspect, adjusting the EDCA parameters to decrease the EDCA aggressiveness may be performed by at least one of increasing a minimum contention window, increasing a maximum contention window, decreasing a transmit opportunity duration, or decreasing an arbitration inter-frame space number

In an aspect, the EDCA adjustment trigger for a bit to cause the neighbor node to decrease the EDCA aggressiveness may be based on at least one of multiple conditions, where the first condition is that the QoS does not satisfy the minimum QoS, the second condition is that the MU is below a minimum MU threshold, the third condition is that the QoS or QoS satisfaction metric is worse than a globally-poor threshold, the fourth condition is that a node stream is a real time, the fifth condition is that a ratio of the node's MU to an average neighbor MU is below a threshold, the sixth condition is that RTS/CTS is already enabled, and the seventh condition is that a rate supported by a link quality is above a threshold. In such an aspect, according to the fifth condition, the node may indicate MU in node's packets. In an aspect, a trigger to decrease the EDCA aggressiveness may be based on at least one of multiple conditions, where the first condition is that a QoS is above a QoS threshold, the second condition is that MU is above an MU threshold, and the third condition is that the stream is non-real time.

In an aspect, the configuration information sent to the node may include first information considered in setting the bit to trigger decreasing the EDCA aggressiveness of the neighbor node, the first information including at least one of a minimum QoS threshold, a minimum MU threshold, or a globally-poor threshold. In an aspect, the configuration information sent to the neighbor node may include second information considered in determining to trigger decreasing the EDCA aggressiveness after receiving the bit, the second information including a QoS threshold per application type and an MU threshold. In an aspect, the configuration information sent to the neighbor node may include EDCA parameters and an amount of EDCA adjustment for each of the parameters for increasing or decreasing an EDCA aggressiveness of the neighbor node. In an aspect, a globally-poor threshold may be a percentile number for QoS satisfaction metrics of all streams within a BSS to which the node belongs, and each QoS satisfaction metric of each stream may be based at least on a ratio of a stream throughput to a respective minimum standard throughput.

In an aspect, the globally-poor threshold may be a largest number of R smallest percentile numbers among a percentile number of QoS satisfaction metrics of streams in a BSS to which the node belongs and percentile numbers of QoS satisfaction metrics of streams in respective neighbor BSSs, R being a positive number. In such an aspect, if the configuring device is an access point, each of the access point in the BSS to which the node belongs and neighbor access points in respective neighbor BSSs may broadcast a respective percentile number for the QoS satisfaction metrics of streams in a corresponding BSS, and the access point may determine the globally-poor threshold based on a percentile number for the access point and percentile numbers for neighbor access points by requesting the node served by the access point to report percentile numbers broadcasted by respective neighbor access points and may send the globally-poor threshold to the node to be configured.

In an aspect, the globally-poor threshold may be a percentile number of QoS satisfaction metric of all streams of a BSS to which the node belongs and neighbor BSSs. In such an aspect, each of an access point in the BSS to which the node belongs and neighbor access points in respective neighbor BSSs may broadcast a respective percentile number for QoS satisfaction metrics of streams in a corresponding BSS, and the access point for the BSS may obtain the QoS satisfaction metrics of all streams of the BSS and the neighbor BSSs, and may determine the percentile number for the QoS satisfaction metrics of all streams by requesting the node served by the access point to report the QoS satisfaction metrics of streams broadcasted by respective neighbor access points.

In an aspect, a receiver of data transmission of the node may send an indicator to the neighbor nodes around the receiver for EDCA adjustment, and the node may request the receiver to send the indicator in the receiver's packets. In an aspect, the adjustment indicator may be directed to a group of neighbor nodes to perform EDCA adjustment on the group of neighbor nodes, the group of neighbor nodes being specified based on at least one of an MU, RSSI, or path loss. In such an aspect, the node may specify numbers and identifiers of the neighbor nodes in the group of neighbor nodes to identify the group of neighbor nodes.

In an aspect, the adjustment indicator may include at least one of a plurality of bits used to specify an amount of EDCA adjustment and EDCA parameters to be adjusted, an expiration time to perform EDCA adjustment, or an RSSI threshold for performing EDCA adjustment. In such an aspect, the adjustment indicator may include metrics to compare with metrics of the neighbor nodes, where the neighbor nodes may perform the EDCA adjustment if the neighbor nodes have better metrics than the indicating node, the metrics including at least one of throughput, a packet delay, MU, or a PER of the node.

In an aspect, the adjustment indicator may include a plurality of bits to indicate a traffic type of the node, the traffic type including at least one of voice, video, best effort, or background, in an order of decreasing access priority, and the neighbor node may decide not to perform EDCA adjustment if the neighbor node's traffic type has a higher priority than the traffic type of the node indicated in the adjustment indicator.

In an aspect, the configuring device may be an access point, and the access point may send an indicator to indicate that the access point supports EDCA adjustment per individual station. In an aspect, the node may send an indicator to indicate that the node supports autonomous EDCA adjustment by the node.

The receiver 1705, the processing system 1710, and/or the transmitter 1715 may be configured to perform one or more functions discussed above with respect to blocks 1002, 1004, and 1006 of FIG. 10 and/or blocks 1102, 1104, 1106, 1108, 1110, and 1112 of FIG. 11, and/or blocks 1202 and 1204 of FIG. 12. The receiver 1705 may correspond to the receiver 212. The processing system 1710 may correspond to the processor 204. The transmitter 1715 may correspond to the transmitter 210.

Moreover, means for obtaining node information of the node may comprise the processing system 1710. Means for receiving configuration information from a configuring device may comprise the processing system 1710 and/or the receiver 1705. Means for determining whether to trigger an EDCA adjustment based on at least one of the configuration information or the node information may comprise the processing system 1710.

Means for determining an amount of the EDCA adjustment if the node determines to trigger the EDCA adjustment may comprise the processing system 1710. Means for adjusting EDCA parameters based on the determined amount may comprise the processing system 1710. Means for identifying the node as a poor node if a minimum QoS is not satisfied and a minimum MU is not satisfied based on the node information may comprise the processing system 1710. Means for determining to trigger the EDCA adjustment of the EDCA parameters to increase an EDCA aggressiveness of the node if the node is identified as the poor node may comprise the processing system 1710. Means for adjusting the EDCA parameters to increase the EDCA aggressiveness further if the minimum QoS and the minimum MU are not satisfied when a first time threshold elapses after a previous EDCA adjustment may comprise the processing system 1710. Means for adjusting the EDCA parameters to decrease the EDCA aggressiveness if the minimum QoS and the minimum MU are satisfied when a second time threshold elapses after a previous EDCA adjustment may comprise the processing system 1710.

Means for sending an adjustment indicator to a neighbor node if the node determines to trigger the EDCA adjustment may comprise the processing system 1710 and/or the transmitter 1715. Means for sending a bit to cause the neighbor node to decrease an EDCA aggressiveness further if a minimum QoS and a minimum MU are not satisfied when a first time threshold elapses after a previous EDCA adjustment may comprise the processing system 1710 and/or the transmitter 1715.

According to another example, the wireless communication device 1700 may be an access point. In such an example, the processing system 1710 may be configured to obtain configuration information of the access point. The processing system 1710 and/or the receiver 1705 may be configured to receive node information from a node. The processing system 1710 may be configured to determine whether to trigger an EDCA adjustment based on at least one of the configuration information or the node information.

The processing system 1710 may be configured to determine an amount of the EDCA adjustment if the access point determines to trigger the EDCA adjustment. The processing system 1710 may be configured to identify the node as a poor node if a minimum QoS is not satisfied and minimum MU is not satisfied based on the node information. The processing system 1710 may be configured to determine to trigger the EDCA adjustment to increase EDCA aggressiveness of the node if the node is identified as the poor node. The processing system 1710 may be configured to increase the EDCA aggressiveness further if the minimum QoS and the minimum MU are not satisfied when a first time threshold elapses after a previous EDCA adjustment. The processing system 1710 may be configured to decrease the EDCA aggressiveness if the minimum QoS and the minimum MU are not satisfied when a second time threshold elapses after a previous EDCA adjustment. The processing system 1710 and/or the transmitter 1715 may be configured to send EDCA parameters based on the determined amount of the EDCA adjustment to the node.

In an aspect, the node information received from the node may include at least one of an MU of the node, QoS of the node, or MU information of neighbor nodes. In such an aspect, the node information may include the QoS of the node if the access point does not measure the QoS, and the node information may include the MU information of the neighbor nodes if the MU information of the neighbor nodes is used in determining whether to trigger the EDCA adjustment, the MU information of the neighbor nodes including at least one of an MU per neighbor node or MU statistics of the neighbor nodes.

In an aspect, the configuration information may include a globally-poor threshold to be used in determining whether to trigger the EDCA adjustment. In such an aspect, the globally-poor threshold may be set by the access point and may be a largest number of R smallest percentile numbers among a percentile number of QoS satisfaction metrics of streams in a BSS to which the node belongs and percentile numbers of QoS satisfaction metrics of streams in respective neighbor BSSs, R being a positive number, and each access point broadcasts a percentile number for QoS satisfaction metric of all streams in a corresponding BSS, and may subsequently determine the globally-poor threshold by requesting a station served by the access point to report percentile numbers broadcasted by respective neighbor access points.

In an aspect, the access point may send a request to the node to report the node information if the access point determines a potential need for increasing an EDCA aggressiveness of the node. In such an aspect, the access point may send the request to the node periodically or whenever the access point detects that the node's QoS does not satisfy a minimum QoS requirement.

In an aspect, the access point may send a configuration message to the node with conditions that are considered in determining whether to send an adjustment request, and if the conditions in the configuration message are satisfied, the node may send an EDCA adjustment request to the access point. In such an aspect, the EDCA adjustment request may include at least one of an indicator for increasing or decreasing EDCA aggressiveness or preferred new EDCA parameters.

The processing system 1710 and/or the transmitter 1715 may be configured to transmit to the node a command for the node to send an adjustment indicator to a neighbor node if the access point determines to trigger the EDCA adjustment. In an aspect, the neighbor node sends the received adjustment indicator and neighbor node information to a neighbor access point serving the neighbor node, and the neighbor node subsequently determines an amount of the EDCA adjustment if the access point determines to trigger the EDCA adjustment and sends EDCA parameters based on the determined amount of the EDCA adjustment to the neighbor node.

In an aspect, the node information received from the node may include at least one of an MU of the node, QoS of the node, or MU information of neighbor nodes. In such an aspect, the node information may include the QoS of the node if the access point does not measure QoS and may include the MU information of the neighbor nodes if the MU information of the neighbor nodes is used in determining whether to trigger the EDCA adjustment, the MU information of the neighbor nodes including at least one of an MU per neighbor node or MU statistics of the neighbor nodes.

In an aspect, the configuration information may include a globally-poor threshold to be used in determining whether to trigger the EDCA adjustment. In such an aspect, the configuring device may be an access point and the globally-poor threshold may be a largest number of R smallest percentile numbers of QoS satisfaction metrics of all streams in a BSS to which the node belongs and neighbor BSSs, R being a positive number, and each access point may broadcast a percentile number for QoS satisfaction metrics of all streams in a corresponding BSS, and may subsequently determine the globally-poor threshold by requesting a station served by the access point to report percentile numbers broadcasted by respective neighbor access points.

The receiver 1705, the processing system 1710, and/or the transmitter 1715 may be configured to perform one or more functions discussed above with respect to blocks 1302, 1304, and 1306 of FIG. 13 and/or blocks 1402, 1404, 1406, 1408, 1410, and 1412 of FIG. 14 and/or block 1502 of FIG. 15. The receiver 1705 may correspond to the receiver 212. The processing system 1710 may correspond to the processor 204. The transmitter 1715 may correspond to the transmitter 210.

Moreover, means for obtaining configuration information of the access point may comprise the processing system 1710. Means for receiving node information from a node may comprise the processing system 1710 and/or the receiver 1705. Means for determining whether to trigger an EDCA adjustment based on at least one of the configuration information or the node information may comprise the processing system 1710.

Means for determining an amount of the EDCA adjustment if the access point determines to trigger the EDCA adjustment may comprise the processing system 1710. Means for sending EDCA parameters based on the determined amount of the EDCA adjustment to the node may comprise the processing system 1710 and/or the transmitter 1715. Means for identifying the node as a poor node if a minimum QoS is not satisfied and minimum MU is not satisfied based on the node information may comprise the processing system 1710. Means for determining to trigger the EDCA adjustment to increase EDCA aggressiveness of the node if the node is identified as the poor node may comprise the processing system 1710. Means for increasing the EDCA aggressiveness further if a minimum QoS and a minimum MU are not satisfied when a first time threshold elapses after a previous EDCA adjustment may comprise the processing system 1710. Means for decreasing the EDCA aggressiveness if the minimum QoS and the minimum MU are satisfied when a second time threshold elapses after a previous EDCA adjustment may comprise the processing system 1710.

Means for transmitting to the node a command for the node to send an adjustment indicator to a neighbor node if the access point determines to trigger the EDCA adjustment may comprise the processing system 1710 and/or the transmitter 1715.

According to another example, the wireless communication device 1700 may be an access point. In such an example, the processing system 1710 and/or the receiver 1705 may be configured to collect node metrics from one or more neighbor access points. The processing system 1710 may be configured to determine an EDCA adjustment of a node served by the access point based on a node metric of the access point and the node metrics of the one or more neighbor access points. At 1606, the processing system 1710 and/or the transmitter 1715 may be configured to coordinate one or more EDCA adjustment phases with the one or more neighbor access points based on the EDCA adjustment of the node.

In an aspect, the access point and the one or more neighbor access points may exchange coordination messages to coordinate the one or more EDCA adjustment phases. In an aspect, each of the one or more EDCA adjustment phases may include a first period to collect the node metrics from one or more neighbor access points, a second period to determine whether to make the EDCA adjustment, and an amount of the EDCA adjustment, and a third period where a node uses adjusted EDCA for transmission. In an aspect, the access point may increase EDCA aggressiveness for nodes in a percentile number if the percentile number is below a first threshold, and the access point may decrease the EDCA aggressiveness for nodes in the percentile number if the percentile number is greater a second threshold, the second threshold being greater than the first threshold.

The receiver 1705, the processing system 1710, and/or the transmitter 1715 may be configured to perform one or more functions discussed above with respect to blocks 1602, 1604, and 1606 of FIG. 16. The receiver 1705 may correspond to the receiver 212. The processing system 1710 may correspond to the processor 204. The transmitter 1715 may correspond to the transmitter 210.

Moreover, means for collecting node metrics from one or more neighbor access points may comprise the processing system 1710 and/or the receiver 1705. Means for determining an EDCA adjustment of a node served by the access point based on a node metric of the access point and the node metrics of the one or more neighbor access points may comprise the processing system 1710. Means for coordinating one or more EDCA adjustment phases with the one or more neighbor access points based on the EDCA adjustment of the node may comprise the processing system 1710 and/or the transmitter 1715.

As used herein, a phrase referring to “at least one of” a list of items refers to any combination of those items, including single members. As an example, “at least one of: A, B, or C” is intended to cover: A, or B, or C, or any combination thereof (e.g., A-B, A-C, B-C, and A-B-C).

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication performed by a node, comprising:
obtaining node information of the node;
receiving configuration information from a configuring device; and
determining whether to trigger an enhanced distributed channel access (EDCA) adjustment based on at least one of the configuration information or the node information.

2. The method of claim 1, further comprising:
determining an amount of the EDCA adjustment if the EDCA adjustment is triggered; and
adjusting at least one of the EDCA parameters based on the determined amount.

3. The method of claim 2, further comprising:
determining that the node is a poor node if a minimum quality of service (QoS) is not satisfied and a minimum medium usage (MU) is not satisfied based on the node information; and
determining to trigger the EDCA adjustment of at least one of the EDCA parameters to increase an EDCA aggressiveness of the node based on the determination that the node is the poor node.

4. The method of claim 3, further comprising:
adjusting at least one of the EDCA parameters to increase the EDCA aggressiveness further if the minimum QoS and the minimum MU are not satisfied when a first time threshold elapses after a previous EDCA adjustment; and
adjusting at least one of the EDCA parameters to decrease the EDCA aggressiveness if the minimum QoS and the minimum MU are satisfied when a second time threshold elapses after a previous EDCA adjustment,
wherein the first time threshold and the second time threshold are included in the configuration information.

5. The method of claim 4, wherein adjusting the at least one of the EDCA parameters to increase the EDCA aggressiveness is performed by at least one of decreasing a minimum contention window, decreasing a maximum contention window, increasing a transmit opportunity duration, or increasing an arbitration inter-frame space number.

6. The method of claim 2, wherein the configuration information includes first information considered in determining to trigger the EDCA adjustment to increase the EDCA aggressiveness, the first information including at least one of a minimum quality of service (QoS) threshold, a minimum medium usage (MU) threshold, or a globally-poor threshold.

7. The method of claim 2, wherein the configuration information includes second information considered in determining to trigger the EDCA adjustment to decrease an EDCA aggressiveness, the second information including a high quality of service (QoS) threshold, and wherein the node adjusts the at least one of the EDCA parameters to decrease the EDCA aggressiveness if QoS of the node is above the high QoS threshold.

8. The method of claim 2, wherein the configuration information includes EDCA parameters and the amount of EDCA adjustment for each of the parameters.

9. The method of claim 8, wherein the amount of EDCA adjustment is based on a number of level increments for respective EDCA parameters or is based on fixed values for respective EDCA parameters.

10. The method of claim 2, wherein the configuration information may be sent to the node from the configuring device in over-the-air (OTA) frames if the configuring device is an access point and the node is a station.

11. The method of claim 10, wherein the OTA frames include at least one of beacon frames, probe/association response frames, or unicast/multicast management frames.

12. The method of claim 1, further comprising:
sending an adjustment indicator to a neighbor node if the node determines to trigger the EDCA adjustment,
wherein the neighbor node determines an amount of the EDCA adjustment after receiving the adjustment indicator and adjusts at least one of EDCA parameters based on the determined amount.

13. The method of claim 12, wherein the neighbor node receives the configuration information from the configuring device.

14. The method of claim 12, further comprising:
sending a bit to cause the neighbor node to decrease an EDCA aggressiveness further if a minimum quality of service (QoS) and a minimum medium usage (MU) are not satisfied when a first time threshold elapses after a previous EDCA adjustment,
wherein the neighbor node adjusts at least one of EDCA parameters to increase the EDCA aggressiveness if the neighbor node does not hear the bit after a second time threshold.

15. The method of claim 14, wherein adjusting the at least one of the EDCA parameters to decrease the EDCA aggressiveness is performed by at least one of increasing a minimum contention window, increasing a maximum contention window, decreasing a transmit opportunity duration, or decreasing an arbitration inter-frame space number.

16. The method of claim 12, wherein a trigger to decrease an EDCA aggressiveness is based on at least one of a plurality of conditions, wherein
a first condition is that a quality of service (QoS) is above a QoS threshold,
a second condition is that a medium usage (MU) is above an MU threshold, and
a third condition is that the stream is non-real time.

17. The method of claim 14, wherein the configuration information sent to the node includes first information considered in setting the bit to trigger decreasing the EDCA aggressiveness of the neighbor node, the first information including at least one of a minimum QoS threshold, a minimum MU threshold, or a globally-poor threshold.

18. The method of claim 14, wherein the configuration information sent to the neighbor node includes second information considered in determining to trigger decreasing the EDCA aggressiveness after receiving the bit, the second information including a QoS threshold per application type and an MU threshold.

19. The method of claim 12, wherein the configuration information sent to the neighbor node includes EDCA parameters and an amount of EDCA adjustment for each of the parameters for increasing or decreasing an EDCA aggressiveness of the neighbor node.

20. The method of claim 12, wherein a receiver of data transmission of the node sends an indicator to the neighbor nodes around the receiver for EDCA adjustment, and wherein the node requests the receiver to send the indicator in the receiver's packets.

21. The method of claim 12, wherein the adjustment indicator is directed to a group of neighbor nodes to perform EDCA adjustment on the group of neighbor nodes, the group of neighbor nodes being specified based on at least one of a medium usage (MU), a received signal strength indicator (RSSI), or path loss.

22. The method of claim 21, wherein the node specifies numbers and identifiers of the neighbor nodes in the group of neighbor nodes to identify the group of neighbor nodes.

23. The method of claim 12, wherein the adjustment indicator includes at least one of a plurality of bits used to specify an amount of EDCA adjustment and at least one of EDCA parameters to be adjusted, an expiration time to perform EDCA adjustment, or a received signal strength indicator (RSSI) threshold for performing EDCA adjustment.

24. The method of claim 23, wherein the adjustment indicator includes metrics to compare with metrics of the neighbor nodes, wherein the neighbor nodes perform the EDCA adjustment if the neighbor nodes have better metrics than the indicating node, the metrics including at least one of throughput, a packet delay, a medium usage (MU), or a packet error rate (PER) of the node.

25. The method of claim 12, wherein the adjustment indicator includes a plurality of bits to indicate a traffic type of the node, the traffic type including at least one of voice, video, best effort, or background, in an order of decreasing access priority, and wherein the neighbor node decides not to perform EDCA adjustment if the neighbor node's traffic type has a higher priority than the traffic type of the node indicated in the adjustment indicator.

26. The method of claim 1, wherein the configuring device is an access point, and wherein the access point sends an indicator to indicate that the access point supports EDCA adjustment per individual station.

27. The method of claim 1, wherein the node sends an indicator to indicate that the node supports autonomous EDCA adjustment by the node.

28. A method of wireless communication performed by an access point, comprising:
obtaining configuration information of the access point;
receiving node information from a node; and
determining whether to trigger an enhanced distributed channel access (EDCA) adjustment based on at least one of the configuration information or the node information.

29. A method of wireless communication performed by an access point, comprising:
collecting node metrics from one or more neighbor access points;
determining an enhanced distributed channel access (EDCA) adjustment of a node served by the access point based on a node metric of the access point and the node metrics of the one or more neighbor access points; and
coordinating one or more EDCA adjustment phases with the one or more neighbor access points based on the EDCA adjustment of the node.

30. An apparatus for wireless communication, wherein the apparatus is a node and comprises:
a memory; and
at least one processor coupled to the memory and configured to:
obtain node information of the node;
receive configuration information from a configuring device; and
determine whether to trigger an enhanced distributed channel access (EDCA) adjustment based on at least one of the configuration information or the node information.
